(19) United States
(12) Patent Application Publication
(10) Pub. No.: US 2020/0147625 A1
(43) Pub. Date: May 14, 2020

(54) SHOWER DEVICE

(71) Applicant: Hyungmin SIM, Seoul (KR)

(72) Inventor: Hyungmin SIM, Seoul (KR)

(21) Appl. No.: 16/627,576

(22) PCT Filed: Jun. 29, 2017
(86) PCT No.: PCT/KR2017/006921

§ 371 Date: Dec. 30, 2019

(51) Int. Cl. B05B 7/28; B05B 1/18

(52) U.S. Cl. CPC B05B 7/28; B05B 1/18

(57) ABSTRACT

The shower device according to the present invention comprises a main flow path connecting the shower hose and the shower head portion, having a central portion extending in an up-downstream direction, and guiding water from the shower hose to the shower head portion. And a main body provided to detachable a cartridge having an inner space formed therein to an outer diameter side of the central portion, and forming a secondary flow path for guiding water from the main flow path to the cartridge.

### FIELD OF THE INVENTION

This invention is for the purpose of mixing predetermined additives with the water during shower. In specific, the design structure of the invention allows additives above to be filled, and provides water paths for water to flow through [Background Art]

Shower Device is a water injection equipment, which is installed in bathrooms or sink. Shower Device is composed of shower hose (3) of which guides water, and showerhead part(5) which discharges water.

Existing Technology locates predetermined additives inside the showerhead's handle, which is mixed with waters from the shower hose, and is eventually discharged from the showerhead nozzles.

### PRIOR ART

Utility Model registration no.20-0184946 (publication date: Jun. 1, 2000)

### DETAILED DESCRIPTION OF THE INVENTION

### Technical Problem

In the pre-existing technology, the container filled with the predetermined additive is disposed inside the handle, and in order to replace it by the exhaustion of the predetermined additive, there is a problem that the handle must be separated and reassembled. The first challenge is to solve this problem.

In the pre-existing technology, the predetermined additive is disposed deep inside the handle part, and it is difficult to easily determine whether the predetermined additive is exhausted from the outside. The second task is to solve this problem.

The pre-existing technology has a problem in that it is inconvenient to use, such as to remove a part containing a predetermined additive in order to take a shower without mixing the predetermined additive in water in a state where the predetermined additive is not exhausted. The 3rd challenge is to solve this problem.

The 4th task of this invention is the apparatus which supplies a predetermined additive by replacement type, and reduces the possibility of water leakage.

The 5th task of the present invention is to enable to control the degree of mixing rate the predetermined additive in water.

The 6th task of the present invention is to enable the additives to be better mixed with water.

The 7th task of the present invention is to preset the direction in which the predetermined additive is supplied to the water, and to ensure that the predetermined flow direction of the water on the flow path is accurately realized.

### Technical Solution

In order to solve the above problems, the shower device according to the solution of the present invention, the connection between the shower hose and the shower head portion, has a central portion extending in the up and down direction, and guides water from the shower hose to the shower head portion And a main body configured to attach and detach a cartridge having an inner space to the outer diameter side of the central portion, and to form a secondary path for guiding water from the main path to the cartridge.

The main body may provide a fixed end to allow the cartridge to be disposed on the outer diameter side of the center portion, and may include a locking portion formed to protrude toward the outer diameter side of the center portion and extend in an up and down direction.

The shower Device may further comprise a cartridge. The cartridge may be formed with an insertion opening that is opened so that the center portion is inserted and fixed. The insertion opening may include a first insertion portion in which the center portion is disposed, and a second insertion portion in which the locking portion is disposed.

The locking portion may be formed within an acute range based on the central axis of the central portion.

The main body may include an upstream step portion formed by extending an upstream portion of the center portion to an outer diameter side, and a downstream step portion formed by extending a downstream portion of the center portion to an outer diameter side. The main body may be provided to sandwich the cartridge between the upstream and downstream steps.

One of the central portion and the cartridge may include a nozzle portion protruding in the other direction, and the other may form a nozzle counterpart recessed in a shape engagable with the nozzle portion. The secondary flow path may be formed in the main body and the cartridge to guide water from the main flow path to the internal space and penetrate the nozzle unit and the nozzle counterpart.

The secondary flow path, may include an upstream secondary flow path guiding water from an upstream portion of the main flow path to the internal space, and a downstream secondary flow path guiding water from the inner space to a downstream portion of the main flow path.

The nozzle counterpart may include: an upstream connecting part configured to protrude so that at least a part of the nozzle part is inserted into an upstream secondary path and form a hole constituting a part of the upstream secondary path; And a downstream connection portion protruding so that at least a portion of the nozzle portion is inserted into the downstream secondary path and forming a hole constituting a portion of the downstream secondary path.

The above shower device may be configured to select any one of a plurality of modes, including an ordinary mode for blocking the secondary flow path and opening the main flow path and, an active mode for opening the secondary flow path and blocking the main flow path. The module may further include.

The plurality of modes may further include an intermediate mode that covers a portion of at least one of the upstream secondary paths and the upstream portion.

The secondary flow path may include an upstream secondary flow path guiding water from an upstream portion of the main flow path to the cartridge, and a downstream secondary flow path guiding water from the cartridge to a downstream portion of the main flow path. The main flow path includes the upstream portion; The downstream portion; And an upstream portion connecting the upstream portion and the downstream portion. The switch module may be provided to block the upstream secondary path in the normal mode and open the upstream secondary path, and to open the upstream secondary path in the active mode and to block the upstream secondary path. The shower device may further include a check valve configured to open and close the downstream secondary flow path to prevent backflow of water on the secondary flow path.

The cartridge may include a first rib that protrudes at one of the upstream end and the downstream end and extends along the circumferential direction, and a first rib groove recessed in a shape that engages the first rib at the other. The main body includes a second rib groove that engages with the first rib when the cartridge is coupled to the main body, and when the cartridge is coupled to the main body. It may include a second rib that is engaged with the first rib groove.

In order to solve the above problems, the shower device according to the solution of the present invention, have a central portion connected between the shower hose and the showerhead, extending in an up-downstream direction, and have a main body forming a main flow path for guiding water from the shower hose to the shower head; And have an auxiliary body provided so that the cartridge with the inner space to be attached and detached to the outer diameter side, the auxiliary body rotatably disposed about the central axis. A secondary flow path may be formed in the main body and the auxiliary body to guide water from the main path to the cartridge. The secondary flow path may be provided to be opened and closed according to the rotation of the auxiliary body.

The auxiliary body may include a central tube portion through which the central portion penetrates the inner diameter side; And a holding part configured to provide a fixed end to allow the cartridge to be disposed on the outer diameter side of the auxiliary body, and to protrude outward from the center tube part and extend in an up-downstream direction.

One of the auxiliary body and the cartridge may include a nozzle portion protruding in the other direction, and the other may form a nozzle counterpart recessed in a shape to engage the nozzle portion. The secondary flow path channel may be formed in the main body, the auxiliary body, and the cartridge to guide water from the main flow path to the internal space, and penetrate the nozzle part and the nozzle counterpart.

In order to solve the above problems, it is possible to implement a cartridge used in the shower device.

### Advantages of the Invention

Through the cartridge coupled on the outer diameter side, there is an effect that the replacement of the cartridge is very convenient. Unlike existing technologies, it is not necessary to peel off parts such as outer casings that form the exterior for replacement of cartridges, and complicated disassembly and assembly for cartridge replacement is unnecessary.

In addition, through the cartridge disposed on the outer diameter side, if at least a part of the outside of the cartridge is made of a transparent material, it is possible to easily determine the degree of exhaustion of the predetermined additives within. It is possible to know the timing accurately and to facilitate the preparation for replacement of the cartridge.

In addition, through the pivotable structure of the auxiliary body or the switch module, the predetermined additive of the shower device according to the rotation of the auxiliary body according to the user's selection, even when the predetermined additives of the cartridge are not exhausted. It is easy to manipulate whether the mixing function is active.

In addition, through the intermediate mode of the switch module, there is an effect that can adjust the level of the predetermined additives in the water.

In addition, through the structure of the locking portion or the holding portion, it is possible to accurately couple the cartridge to a predetermined position, there is an effect that can be stably maintained the coupled state of the cartridge. Furthermore, when the engaging portion or the holding portion is formed in the acute angle range (a) with respect to the central axis (X), it is easy to elastically couple or detach the cartridge, while the main body in the state that the cartridge is coupled It may be stably attached to the main body or the auxiliary body.

In addition, when the cartridge is rotated while the cartridge is coupled to the auxiliary body through the holding part of the auxiliary body, a rotational force is applied to the auxiliary body. The user can grip the outer diameter side of the cartridge, so that the user can apply a relatively large torque to the auxiliary body with a small force.

Through the structure of the nozzle portion and the nozzle counterpart, it is possible to obtain a beneficial effect by attaching and detaching the cartridge from the outer diameter side, and to block leakage that may occur as the cartridge is disposed on the outer diameter side. Furthermore, the single leakage blocking function in which the cartridge wraps around the center or the outer diameter side of the center tube portion, and the double leakage blocking function in which the nozzle portion is wrapped in the nozzle counterpart are exhibited, so that the possibility of leakage is significantly reduced.

The triple leakage blocking function for inserting the upstream connecting portion and the downstream connecting portion into the upstream secondary path path and the downstream secondary path, respectively, is exerted, thereby reducing the possibility of water leakage.

By allowing the upstream secondary path and the downstream secondary path to pass through the common nozzle portion, there is an effect of improving the leakage blocking performance of two points with a minimum structure.

Through the gasket and/or the packing part, there is an effect of further improving the leakage performance between the nozzle part and the nozzle counterpart.

Through the vortex forming section, water containing predetermined additives flowing out from the secondary flow path to the downstream section can be mixed with the water flowing out of the downstream section to the downstream section. This is particularly advantageous in the intermediate mode state.

Through the structure of the rib and the rib groove, it is possible to stack a plurality of cartridges more stably in a narrow space more stably, and to increase the coupling force between the cartridge and the main body, and furthermore, it is also possible to prevent leakage between the main bodies.

### BRIEF DESCRIPTION OF THE DRAWINGS

FIG. 1 is a perspective view showing a main body (110) according to a 1st embodiment of the present invention.

FIG. 2 is an elevation view of the main body (110) shown in FIG. 1 as seen from the outer diameter side.

FIG. 3 is a perspective view showing cartridges (150) and (250) according to the first and second embodiments of the present invention.

FIG. 4 is an elevation view of the cartridges (150) and (250) shown in FIG. 3 as viewed from the upstream side.

FIG. 5 is a perspective view of the shower device (101) according to the first embodiment in which the main body (110) of FIG. 1 and the cartridge (150) of FIG. 3 are combined.

FIG. 6 is a cross-sectional view of the shower device (101) of FIG. 5 taken horizontally along the line S1-S1′.

FIG. 7 is a cross-sectional view taken vertically along the line S2-S2 of the shower device (101) of FIG. 5, with enlarged views of portions Y1 and Y2.

FIG. 8 is a perspective view showing a main body (210) according to a second embodiment of the present invention.

FIG. 9 is an elevation view of the main body (210) shown in FIG. 8 (FIG. 8) as seen from the outer diameter side.

FIG. 10 is a perspective view showing a secondary body (230) according to the second embodiment of the present invention.

FIG. 11 is a perspective view of the secondary body (230) shown in FIG. 10 viewed from another angle.

FIG. 12 is an elevation view of the auxiliary body (230) shown in FIG. 10 as viewed from the downstream side.

FIG. 13 is a perspective view that illustrates shower device (201) of the second embodiment in which the main body (210) of FIG. 8, the auxiliary body (230) of FIG. 10, and the cartridge (250) of FIG. 3 are assembled.

FIG. 14 is a perspective view illustrating the shower device (201a) with the cartridge (250) removed from the shower device (201) of FIG. 13.

FIG. 15 is a cross-sectional view taken along the line S3-S3 of the shower device (201) of FIG.

FIG. 16 is a cross-sectional view of the shower device (201) of FIG. 13 taken horizontally along the line S4-S4, showing a state where the downstream secondary (18b) is blocked.

FIG. 17 is a cross-sectional view of the shower device (201) of FIG. 13 taken horizontally along the line S4-S4, showing a state in which the downstream basin (18b) is opened.

FIG. 18 is a cross-sectional view taken vertically along the line S5-S5 of the shower device (201) of FIG. 13, with enlarged views of portions (Y3) and (Y4).

FIG. 19 is a perspective view showing a structure for stacking a plurality of cartridges (50) according to an embodiment of the present invention.

FIG. 20 is a partial cross-sectional view of the cartridge (50) of FIG. 19 cut vertically along the line S6-S6.

FIG. 21 is a perspective view showing the appearance of a state where a plurality of cartridges (50) of FIG. 19 are stacked.

FIG. 22 is a perspective view showing a main body (310) according to a third embodiment of the present invention.

FIG. 23 is a perspective view of the main body (310) of FIG. 22 viewed from another angle.

FIG. 24 is an elevation view of the main body (310) shown in FIG. 22 as seen from the outer diameter side.

FIG. 25 is an elevation view of the main body (310) of FIG. 24 viewed from different angles, and is an elevation view of the nozzle unit (91) facing the front.

FIG. 26 is a perspective view showing cartridges (350) and (450) according to the third and fourth embodiments of the present invention.

FIG. 27 is a cross-sectional view of the cartridges (350) and (450) of FIG. 26 cut vertically along the line S7-S7.

FIG. 28 is a perspective view illustrating the shower device (301) according to the third embodiment in which the main body (310) of FIG. 22 and the cartridge (350) of FIG. 26 are combined.

FIG. 29 is a cross-sectional view of the shower device (301) of FIG. 28 cut horizontally along the line S8-S8.

FIG. 30 is a cross-sectional view of the shower device (301) of FIG. 28 cut horizontally along the line S9-S9.

While, FIG. 31a and FIG. 31b is a Cross-section of the shower device (301) cut in the direction of line S10-S10, FIG. 31a illustrates the open state of check-valve allowing the downstream secondary flow path, whereas FIG. 31b illustrates the closed state of check-valve blocking the downstream secondary flow path.

FIG. 32 and FIG. 33 are exploded perspective views of the main body (310) of FIG. 22.

FIG. 34 is the perspective view of FIG. 32, Central Case(10b) of FIG. 33, and switch module (70).

FIG. 35A to FIG. 35C, which are elevation views of the middle case (10b) and the switch module (70) of FIG. 34 as viewed from the upstream side, FIG. 35A shows the state of the switch module(70) in the normal mode, and FIG. 35B shows the state of the switch module(70) in the active mode, and FIG. 35C shows the state of the switch module (70) in the intermediate mode.

FIG. 36 is a perspective view of the switch module (70) of FIG. 34.

FIG. 37 is a cross-sectional view of the switch module (70) of FIG. 36 cut vertically along the line S11-S11.

FIG. 38 is a perspective view of the intermediate case (10b) and the check valve (80) of FIGS. 32 and FIG. 33.

FIG. 39 is a cross-sectional view of the shower device (401) according to the fourth embodiment in which the main body (410), the auxiliary body (430), and the cartridge (450) are coupled according to the fourth embodiment.

FIG. 40 is a perspective view illustrating a use state in which the shower device (1) according to an embodiment of the present invention is connected to the shower hose (3) and the shower head portion (5).

### MODE FOR INVENTION

Throughout the specification, the expression ‘Central Axis (X)’ refers to a virtual axis extending through the center of the main body (10) to be described later and extending in an up-downstream direction. The expression ‘Outer Diameter’ means outer diameter, ‘Inner Diameter’ means inner diameter, and ‘Outer diameter’ means away from the central axis (X). It means the direction, ‘inner diameter side’ means the direction closer to the central axis (X). In addition, throughout the specification, the distinction between upstream and downstream is based on the direction in which water flows in the state in which the shower device (1) of the present invention is connected to the shower hose (3) and the shower head portion (5). ‘Upstream Side’ refers to the direction of water flowing into the shower device (1), and ‘Downstream Side’ refers to the direction of water flowing out of the shower device (1). In addition, the “circumferential direction” means a circumferential direction around the central axis (X). In the drawings, the central axis (X), the outer diameter side (XO), the inner diameter side (XI), the upstream side (U) and the downstream side (D) are shown. This suggests a criterion to explain the present invention so that the present invention can be clearly understood, and each direction may be defined differently according to other criteria.

The use of terms such as ‘first’ and ‘second’ in front of components mentioned below are used only to avoid confusion of components to which they refer, and the order, importance or main relationship between the components. It is irrelevant.

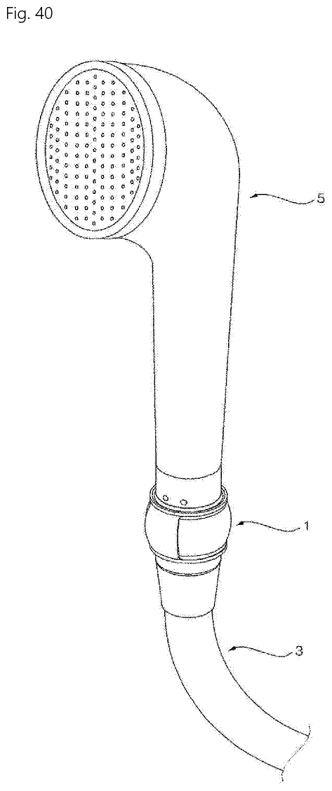

Referring to FIG. 40, the shower device (1) according to the present invention is a device connected between the shower hose (3) and the shower head part (5). Typically, the shower head portion (5) is a component for injecting water to the user, a plurality of injection holes are provided on the downstream side. The shower hose (3) is a hose for guiding water to the shower head portion (5), which is typically connected from the faucet to the upstream portion of the shower head portion (5).

In the use state in which the shower device (1) is connected to the shower hose 3 and the shower head part (5), the shower device (1) forms a flow path between the shower hose (3) and the shower head part (5), and the shower The water introduced from the hose (3) may be mixed with predetermined additives (Z), which will be described later, to flow out to the shower head (5). Hereinafter, with respect to the configuration referring to the flow path formed in the shower device (1), ‘start’ and ‘end’ of the flow path refers to the ‘upstream end’ and ‘downstream end’ of the flow path respectively referred to based on the flow of water do.

The shower device (1) includes a main body (10) connecting between the shower hose 3 and the shower head portion (5). This means that the main body (10) is configured to connect between the shower hose (3) and the shower head portion (5), and the shower hose (3) and the shower head portion (5) are the shower device of the present invention (1) is only a peripheral configuration in the operating state of operation is not a configuration of the present invention. According to the embodiment, the shower device (1) and the shower hose (3) may be composed of an integral part, and the shower device (1) and the shower head part (5) may be composed of an integral part, and the shower device (1) and the shower hose (3) and the shower head portion (5) may all be composed of separate components that can be combined and separated.

The main body (10) includes a central portion (12) extending in the up-downstream direction. The central portion (12) extends along the central axis (X).

The main body (10) forms a main flow path (11) for guiding water from the shower hose (3) to the shower head portion (5). The main flow path (11) penetrates the main body (10) in an up-downstream direction. The main flow path (11) may pass through the central portion (12), and the main flow path (11) may pass through the locking portion (16) to be described later.

The shower device (1) includes a cartridge (50) that forms an internal space (51s). The internal space (51s) is filled with predetermined additives Z (predetermined additives). In the shower device (1) to which the cartridge (50) is coupled, the internal space (51s) may be disposed along the circumference of the central portion (12).

The cartridge (50) is provided to be detachable to the main body (10) or the auxiliary body (30) to be described later. The cartridge (50) may be disposed along the circumference of the central portion (12). The cartridge (50) is provided to be detachable to the outer diameter side of the main body (10).

In the first and third embodiments, the cartridges (150) and (350) are provided to be detachable to the outer diameter side of the central portion (12). The cartridges (250) and (450) may be provided to be detachable while elastically surrounding the periphery of the central portion (12).

In the second and fourth embodiments, the cartridges (250) and (450) are provided to be detachable to the outer diameter side of the auxiliary body (30). The cartridges (250) and (450) may be provided to be detachable while elastically surrounding the circumference of the center tube part (31).

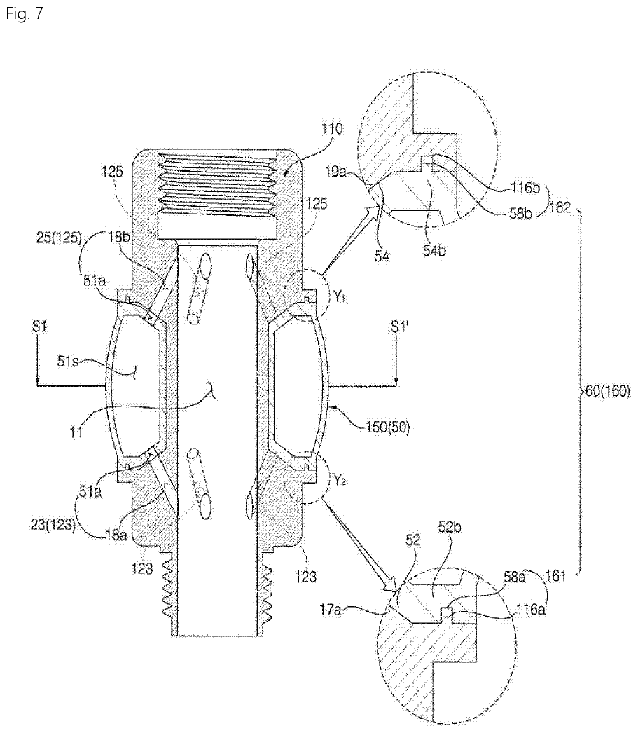

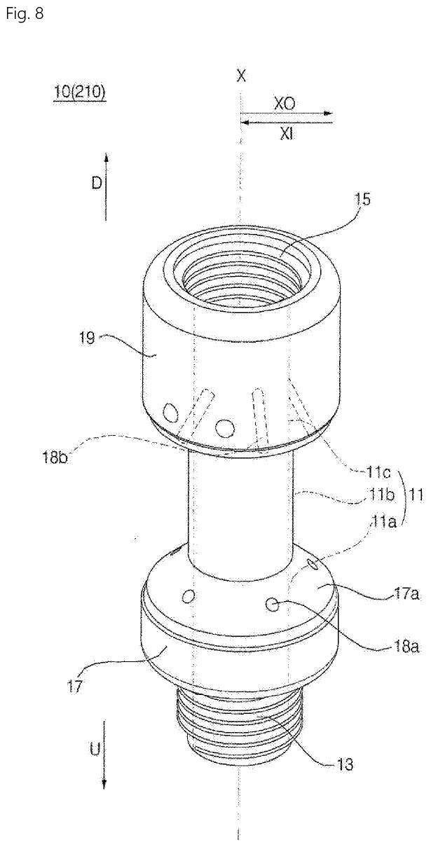

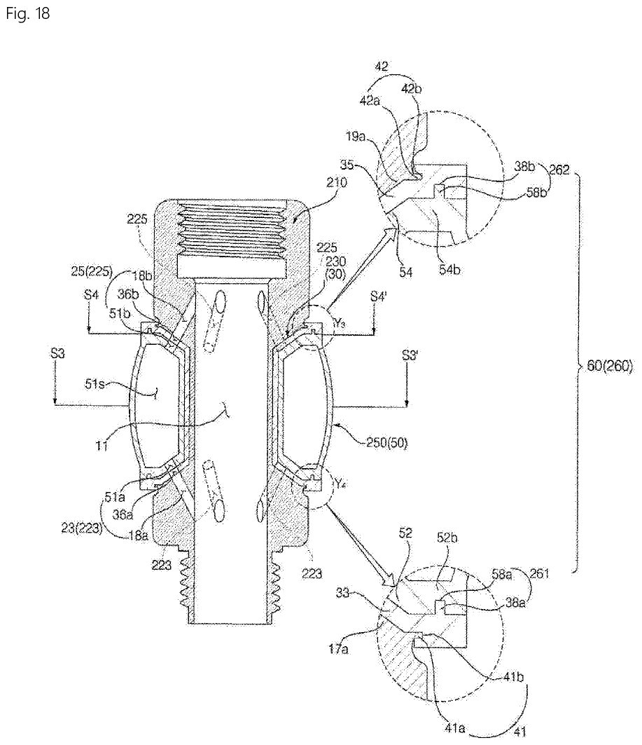

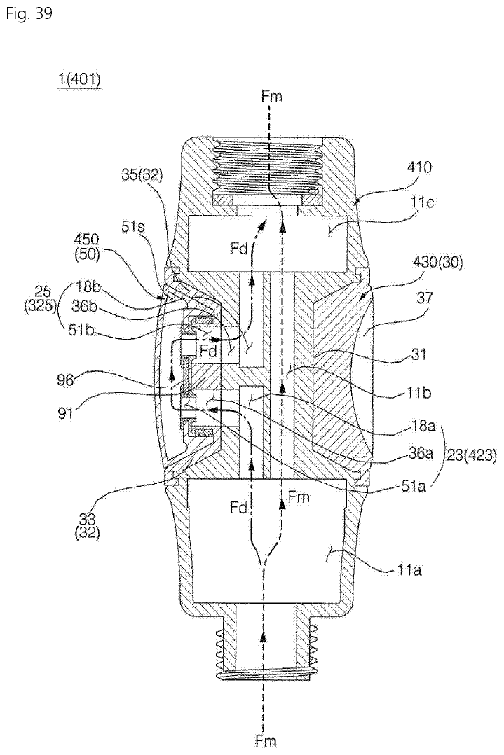

FIG. 7, FIG. 18, FIG. 31A and FIG. 39, the shower device (1) forms secondary paths (23) and (25) for guiding water from the main path (11) to the internal space (51s).

In the first and third embodiments, the main body (110, 310), have an upstream branch passage (18a) for guiding water from the upstream portion (11a) to the cartridges (150, 350), and have downstream secondary flow path for guiding water from the cartridges (150, 350) to the downstream portion (11c).// The main body (110, 310) and the cartridges (150, 350) forms upstream branch passages (18a,51a) for guiding water from the upstream portion (11a) to the internal space 51s, and downstream branch passages (18b, 51b) for guiding water from the internal space (51s) to the downstream portion (11c).

In the second and fourth embodiments, the main body (210, 410) and the auxiliary body (230, 430) have upstream secondary flow path (18a, 36a) for guiding water from the upstream portion (11a) to the cartridges (250, 450), and downstream secondary path (18b, 36b) for guiding water from the cartridges (250, 450) to the downstream portions (11c). The main body(210, 410), the subsidiary body(230, 430), and the cartridge(250, 450) include upstream branch passage (18b), (36b), and (51b) for guiding water from the upstream portion (11a) to the inner space (51s), and downstream branch flow paths for guiding water from the inner space (51s) to the downstream portion (11c).

The main body (10) is provided with an upstream secondary (18a) constituting at least a portion of the upstream secondary path (23) and a downstream secondary (18b) constituting at least a portion of the downstream secondary path (25). The auxiliary body (30) is provided with an upstream connecting hole (36a) constituting at least a portion of the upstream secondary path (23) and a downstream connecting hole 36b constituting at least a portion of the downstream secondary path (25). The cartridge (50) is provided with an upstream communication hole (51a) constituting at least a portion of the upstream secondary path (23) and a downstream communication hole (51b) constituting at least a portion of the downstream secondary path (25).

The main flow path (11) may include an upstream portion (11a), a downstream portion (11c), and an intermediate portion (11b) connecting the upstream portion (11a) and the downstream portion (11c). The upstream portion 11a may refer to an upstream region where the secondary flow paths 23 and 25 secondary from the main flow path 11, and the downstream portion 11c may include the secondary flow paths 23 and 25 as the main flow path 11. The edge may refer to the downstream region.

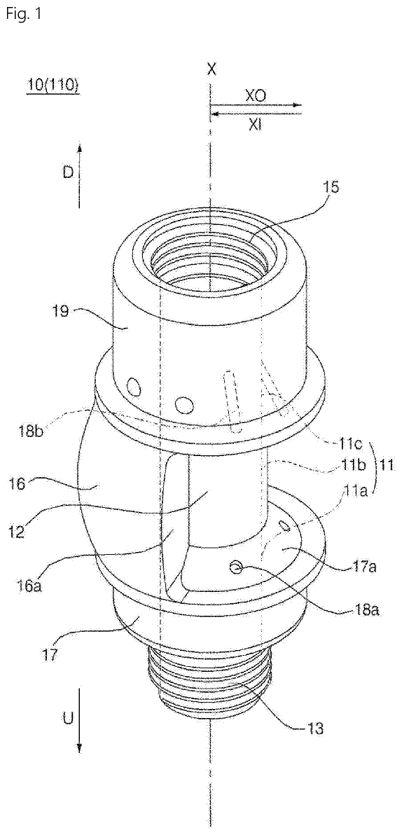

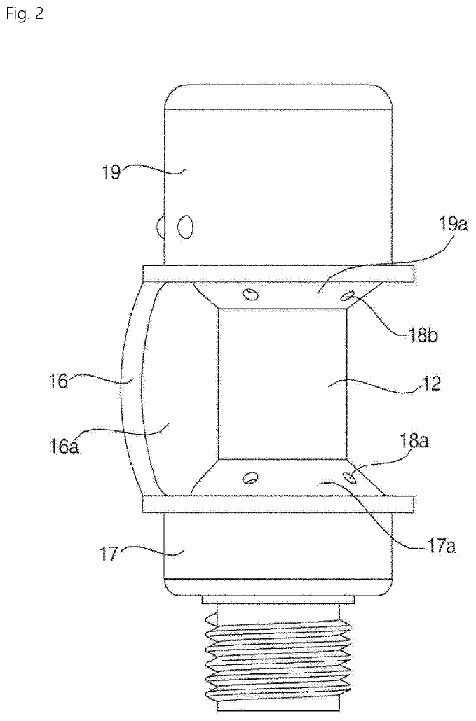

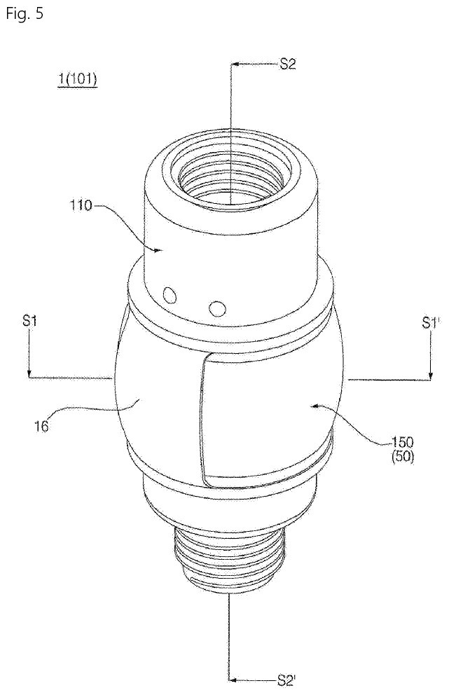

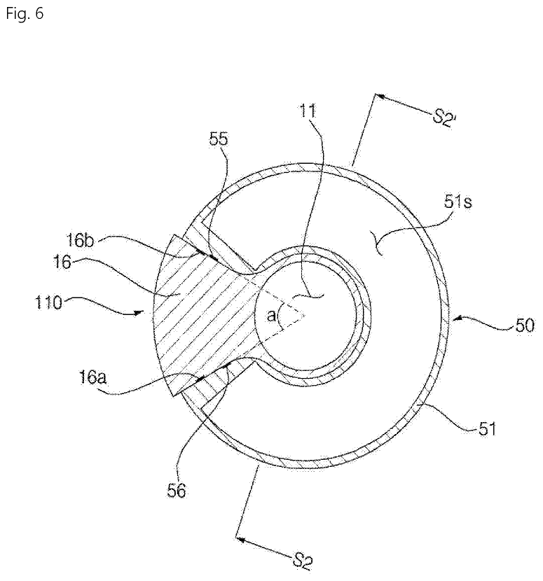

FIG. 1 to FIG. 7, the shower device 101 according to the first embodiment will be described as follows. The shower device 101 includes a main body 110 and a cartridge 150 according to the first embodiment.

The main body 110 includes a hose connecting portion 13 formed to be connectable with the shower hose 3. The hose connecting portion 13 is formed upstream of the main body 110. The hose connection part 13 may include a screw extending in a helical direction along a circumference of an upstream portion of the main body 110 so as to be screwable with the shower hose 3.

The main body 110 includes a head connecting portion 15 formed to be connectable with the shower head portion 5. The head connecting portion 15 is formed downstream of the main body 110. The head connection part 15 may include a screw extending in a helical direction along the circumference of the downstream portion of the main body 110 so as to be screwable with the shower head part 5.

The main body 110 includes an upstream step 17 formed by extending an upstream portion of the central portion 12 to the outer diameter side. The main body 110 includes a downstream step portion 19 formed by extending a downstream portion of the central portion 12 toward the outer diameter side. The outer diameter of the upstream step 17 and the outer diameter of the downstream step 19 may be larger than the outer diameter of the central portion 12. The hose connecting portion 13 may be disposed upstream of the upstream step 17, and the head connecting portion 15 may be disposed downstream of the downstream step 19.

A step is formed between the upstream step (17) and the central part (12). The downstream facing surface 17a of the upstream step 17 forms a surface that connects the step between the upstream step 17 and the central portion 12. Although the downstream facing surface 17a may be disposed at right angles to the central axis X, the inclined surface may be formed to be closer to the central axis X in the downstream direction as in the present embodiment. The downstream facing surface 17a extends in the circumferential direction and may be formed to form a part of the shape of the side surface of the cone as a whole.

A step is formed between the downstream step portion 19 and the central portion 12. The upstream facing surface 17a of the downstream stepped portion 19 forms a surface connecting the step between the downstream stepped portion 19 and the central portion 12. The upstream facing surface 17a may be disposed at right angles to the central axis X. However, the inclined surface may be formed to be closer to the central axis X in the upstream direction as in the present embodiment. The upstream facing surface 17a extends along the circumferential direction and may be formed to form a part of the shape of the side surface of the cone as a whole.

The main body 110 is provided to sandwich the cartridge 50 between the upstream step 17 and the downstream step 19.

The upstream secondary hole 18a is formed by connecting the main flow path 11 and the surface of the main body 110 in contact with the cartridge 50. An end of the upstream secondary 18a is formed on the face of the main body 110 in contact with the cartridge 50. The end of the upstream secondary ing port 18a may be disposed at the downstream facing surface 17a. The plurality of upstream secondary 18a may be spaced apart from each other along the circumferential direction.

The downstream secondary 18b is formed by connecting the main flow path 11 and the surface of the main body 110 in contact with the cartridge 50. On the face of the main body 110 in contact with the cartridge 50, the start end of the downstream secondary 18b is formed. The start end of the downstream secondary 18b may be disposed on the upstream facing surface 17a. A plurality of downstream secondary 18b may be arranged spaced apart from each other along the circumferential direction.

The main body 110 includes a locking portion 16 protruding from the central portion 12 to the outer diameter side. The locking portion 16 is formed extending in the up-downstream direction.

The engaging portion 16 provides a fixed end so that the cartridge 50 can be disposed on the outer diameter side of the main body 110. The catching portion 16 provides a fixed end so that the cartridge 50 can be fixedly arranged around the main body 110.

The locking portion 16 may be formed in the acute angle range a based on the central axis X of the central portion 12. The engaging portion 16 and the second insertion portion 573 are formed within the acute angle (a), so that the cartridge 50 is elastically coupled or detached easily, while the cartridge 50 is coupled to the main It can be attached to the body 10 stably.

The inner diameter side surface of the locking portion 16 is fixed to the central portion 12. Both ends of the up-downstream direction of the locking portion 16 are fixed to the downstream facing surface 17a and the upstream facing surface 17a, respectively. The outer diameter side surface of the locking portion 16 may be formed as a curved surface convex toward the outer diameter side. In order to increase the friction force when the user grips the shower device 1, grooves or protrusions may be formed on the outer diameter side of the locking portion 16.

With the cartridge 50 coupled to the main body 110, the circumferential opposite sides 16a and 16b of the engaging portion 16 may contact the circumferential opposite sides 56 and 55 of the cartridge 50, respectively.

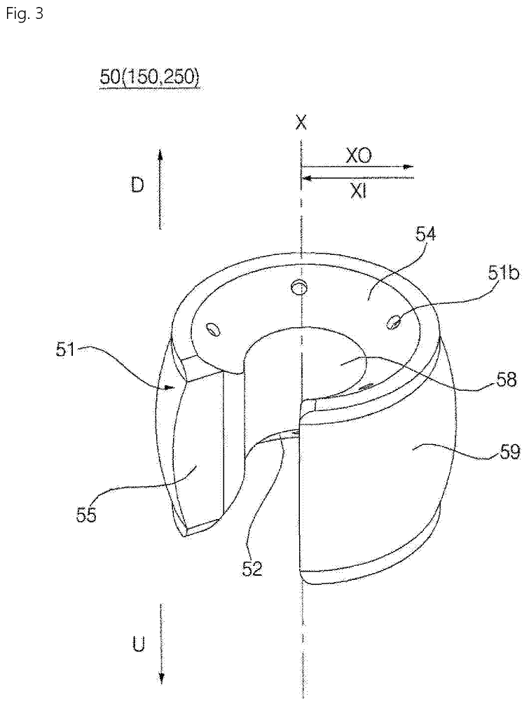

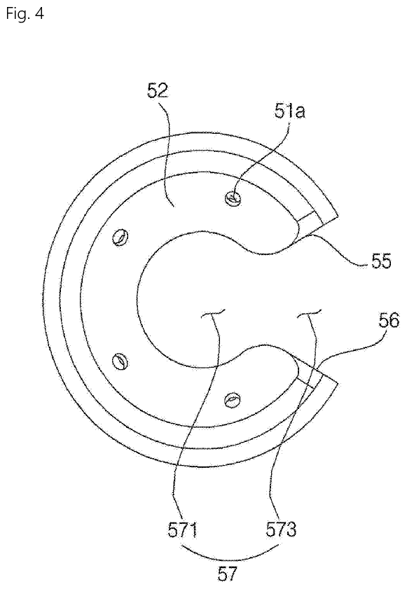

FIG. 3 to FIG. 7, the cartridge 50 includes a case 51 forming an appearance. Referring to the components of the case 51 on the basis of the state in which the cartridge 50 is attached to the main body 110 as follows. The case 51 has an upstream side surface 52 in contact with the downstream facing surface 17a of the upstream stepped section 17, and a downstream side surface 54 in contact with the upstream facing surface 17a of the downstream stepped section 19. It includes. The case 51 includes an inner diameter side surface 58 and an outer diameter side surface 59 in contact with the outer diameter surface of the central portion 12. The outer diameter side surface 59 may form a curved surface convex toward the outer diameter side. The case 51 has a circumferential side surface 55 in contact with the circumferential side surface 16b of the locking portion 16, and a circumferential direction other surface in contact with the other circumferential side surface 16a of the locking portion 16. Side 56.

The inner space 51s of the case 51 forms a space elongated in the circumferential direction, and is disposed around the central portion 12 in a state where the cartridge 50 is attached to the main body 110. The case 51 may be formed in a columnar shape having a bottom of a horseshoe shape as a whole.

The cartridge 50 is formed with an insertion opening 57 that is opened so that the center portion 12 is inserted. The insertion opening 57 includes a first insertion portion 571 in which the central portion 12 is disposed, and a second insertion portion 573 in which the locking portion 16 is disposed. The insertion opening 57 extends along the central axis X so that the upstream end and the downstream end communicate with each other. The first inserting portion 571 is disposed along the central axis X. The second inserting portion 573 is formed by opening a part of the circumference of the first inserting portion 571 to the outer diameter side. The second insertion part 573 is formed within an acute angle range with respect to the central axis X.

The upstream side surface 52 may have an inclination corresponding to the downstream opposing surface 17a of the upstream step 17. The upstream side surface 52 may form an inclined surface closer to the central axis X toward the downstream direction. The upstream side surface 52 may extend along the circumferential direction and may be formed to form a part of the side surface shape of the funnel as a whole.

The downstream side 54 may have a slope corresponding to the upstream facing surface 17a of the downstream step portion 19. The downstream side 54 may form an inclined surface closer to the central axis X toward the upstream direction. The downstream side 54 may extend along the circumferential direction, so as to form part of the side face shape of the funnel as a whole.

The upstream communication hole 51a is formed by connecting the ‘surface of the cartridge 150 in contact with the main body 110’ and the ‘inner side partitioning the inner space 51s’. An upstream end of the upstream communication hole 51a is formed on the surface of the cartridge 150 in contact with the main body 110. The start end of the upstream communication hole 51a may be disposed on the upstream side surface 52. The plurality of upstream communication holes 51a may be spaced apart from each other in the circumferential direction. The start end of the upstream communication hole 51a is disposed at a position corresponding to the end of the upstream secondary port 18a.

The downstream communication hole 51b is formed by connecting the ‘surface of the cartridge 150 in contact with the main body 110’ and the ‘inner side partitioning the inner space 51s’. An end of the downstream communication hole 51b is formed on the surface of the cartridge 150 in contact with the main body 110. An end of the downstream communication hole 51b may be disposed on the downstream side 54. The plurality of downstream communication holes 51b may be spaced apart from each other in the circumferential direction. The end of the downstream communication hole 51b is disposed at a position corresponding to the start end of the downstream secondary port 18b. The downstream communication hole 51b is formed by connecting the ‘surface of the cartridge 150 in contact with the main body 110’ and the ‘inner side partitioning the inner space 51s’. An end of the downstream communication hole 51b is formed on the surface of the cartridge 150 in contact with the main body 110. An end of the downstream communication hole 51b may be disposed on the downstream side 54. The plurality of downstream communication holes 51b may be spaced apart from each other in the circumferential direction. The end of the downstream communication hole 51b is disposed at a position corresponding to the start end of the downstream secondary port 18b.

The case 51 may be formed in a symmetrical shape in the up-downstream direction.

Although not shown in the drawings, at least a portion of the outer diameter side surface 59 of the cartridge 50 may be made of a transparent material. Through this, it is possible to easily determine the degree of exhaustion (predetermined additives) in the internal space, it is possible to know exactly when to replace the cartridge 50 and to prepare in advance for replacement of the cartridge 50 Becomes easy.

Predetermined additives (Z) may consist of a variety of known ingredients, such as tea ingredients, aroma ingredients, cosmetic ingredients such as collagen, vitamin ingredients, or combinations thereof, for therapy showers. Predetermined additives (Z) may consist of solid components such as gels. The inner space 51s may be provided with a separate additive case (not shown) filled with predetermined additives Z, and a hole (not shown) may be formed in the additive case.

A filter (not shown) may be disposed in the internal space 51s. The filter may prevent particles, such as agglomerates, from getting out of the solid when the water introduced into the internal space 51s and mixed with predetermined additives Z flows out of the internal space 51s. In another embodiment, the filter may perform a water purification function for the water flowing out after entering the internal space (51s).

Moreover, another well-known means is arrange I positioned in the said internal space 51s, and it can also make it exert a residual chlorine removal function or a softening function with respect to the water which flows out after entering into the internal space 51s.

Referring to FIG. 7, the upstream communication hole 51a and the upstream secondary flow path port (18a) may be connected to form an upstream secondary path 123. The downstream communication hole 51b and the downstream secondary port 18b may be connected to form the downstream secondary flow path 125.

The upstream secondary flow path 123 and the downstream secondary flow path 125 may be formed by bending the outer diameter side from the main flow path 11. Through this, the flow path resistance of the water flow flowing through the upstream secondary flow path 123 and the downstream secondary flow path 125 can be made larger than the flow resistance of the water flow flowing through the main flow path 11. While water is being supplied to the shower device 101 using the cartridge 50 filled with predetermined additives Z, excessively strong water flow flows into the internal space 51s of the cartridge 50 and is excessive. It is possible to prevent the exhaustion of predetermined additives Z in a short time.

The upstream secondary path 123 forms a start end in the upstream portion 11a and may extend obliquely in a direction away from the central axis X toward the downstream direction. The downstream secondary flow path 125 forms a terminal at the downstream portion 11c and may extend obliquely in a direction away from the central axis X toward the upstream direction.

The upstream secondary path 123 and the downstream secondary path 125 may be arranged in a plurality, respectively, spaced apart from each other along the circumferential direction. In this way, it is possible to disperse the water flow and to evenly disperse the concentration of predetermined additives (Z) filled in the circumferential direction in the inner space 51s without being concentrated at any particular point.

Referring to FIG. 7, the shower device 101 may further include a coupling unit 160 for coupling the main body 110 and the cartridge 50 to each other. The coupling unit 160 may prevent leakage between the main body 110 and the cartridge 50. In order to prevent leakage, an elastic material such as rubber (not shown) may be disposed between the main body 110 and the cartridge 50.

The coupling part 160 may be formed by a rib protruding from one of the main body 110 and the cartridge 50 and a groove recessed in a shape that engages the rib in the other.

Coupling portion 160, the first coupling portion 161 for coupling the downstream facing surface 17a and the upstream side 52 and the upstream facing surface 17a and downstream side 54 for coupling with each other It may include a second coupling portion 162. The first coupling portion 161 may prevent leakage between the downstream facing surface 17a and the upstream side surface 52. The second coupling portion 162 may prevent leakage between the upstream facing surface 17a and the downstream side 54.

The first coupling part 161 may be provided such that the ribs protruding from one of the downstream facing surface 17a and the upstream side 52 and the groove recessed in engagement with the other are engaged with each other. In the first embodiment, the ribs and the grooves of the first coupling part 161 are the second ribs 116a and the first rib grooves 58a, which will be described later, respectively.

The second engagement portion 162 may be provided such that the ribs protruding from either the upstream facing surface 19a or the downstream side 54 and the recessed grooves engaged with each other engage with each other. In the first embodiment, the ribs and the grooves of the second coupling portion 162 are first ribs 58b and second rib grooves 116b, which will be described later, respectively.

The case 51 of the cartridge 50 may be formed with a protrusion projecting from one of the upstream end 52b and the downstream end 54b and a recess recessed in a shape to engage the protrusion at the other. The protrusions and the grooves of the cartridge 50 may be first ribs 58b and first rib grooves 58a, which will be described later, respectively. As illustrated in FIG. 21, when the plurality of cartridges 50 are stacked, the protrusions and the grooves may be engaged with each other.

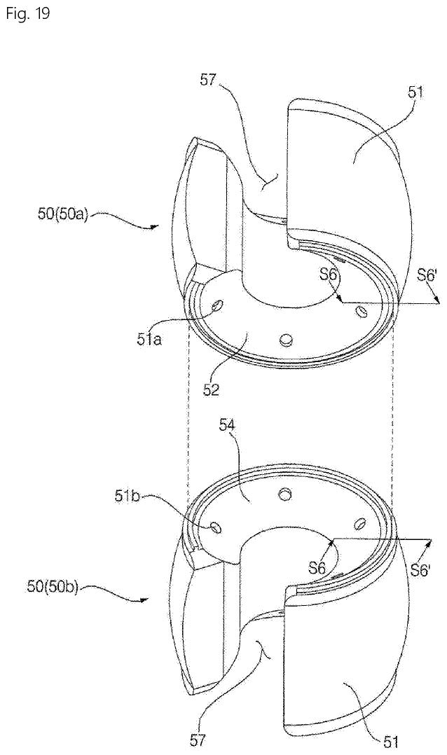

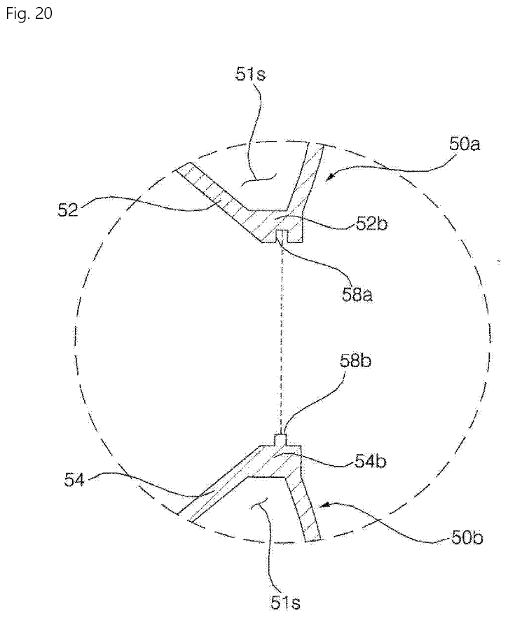

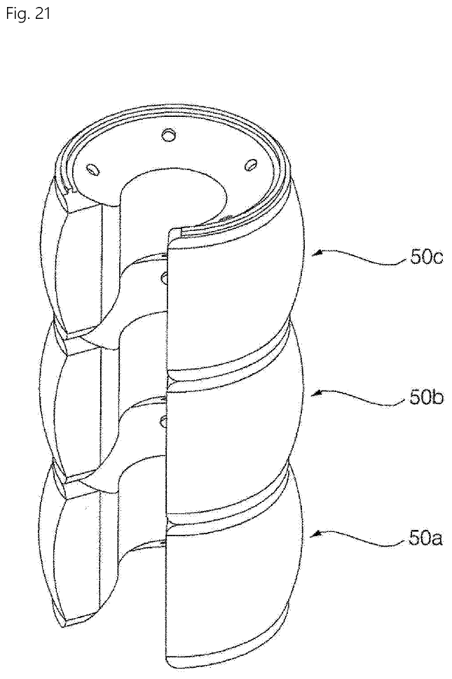

FIG. 7, FIG. 19 and FIG. 20, the cartridge 50 has a first rib 58b protruding from one of the upstream ends 52b and 54b and extending along the circumferential direction and the other. And a first rib groove 58a recessed in a shape that engages with the first rib 58b. When the plurality of cartridges 50a, 50b, and 50c are stacked, the first rib 58b of one cartridge 50a and the first rib groove 58a of the other cartridge 50b are provided to be engaged with each other do. The first rib 58b and the first rib groove 58a are advantageously disposed farther from the central axis X than the upstream communication hole 51a and the downstream communication hole 51b in terms of exhibiting a leakage preventing function..

The main body 110 includes a second rib groove 116b that engages the first rib 58b when the cartridge 50 is coupled to the main body 110, and the cartridge 50 includes the main body 110. And a second rib 116a that engages the first rib groove 58a when coupled thereto.

The second rib groove 116b and the first rib groove 58a are recessed in the shape of engaging with the first rib 58b. The first rib 58b and the second rib 116a protrude in a shape that engages the first rib groove 58a.

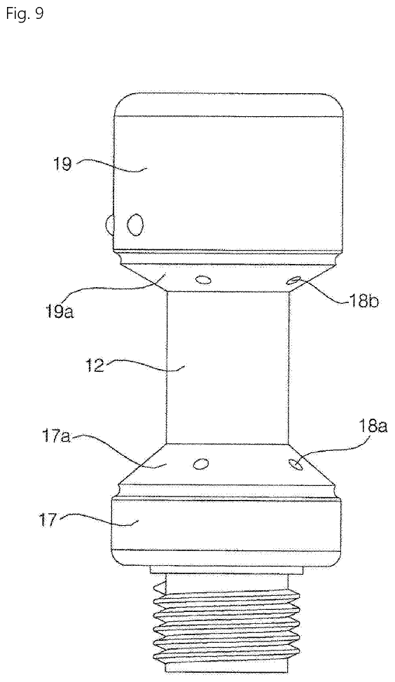

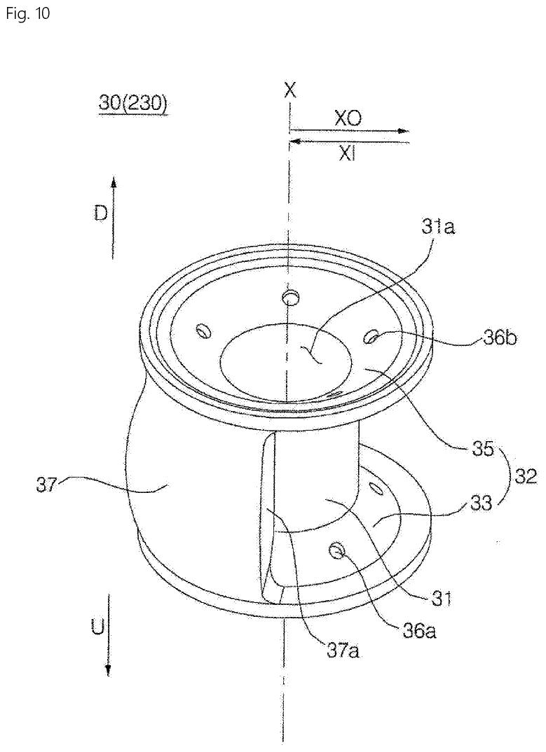

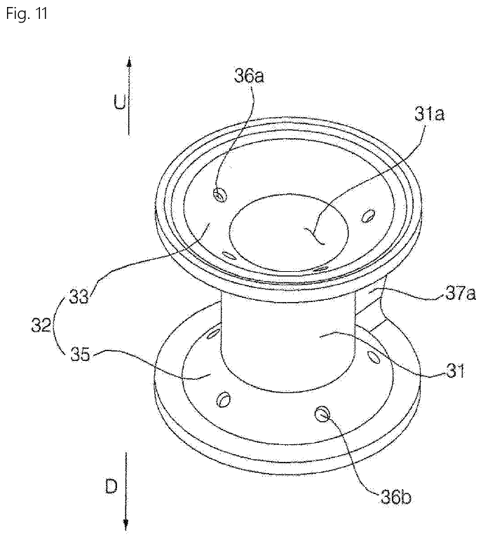

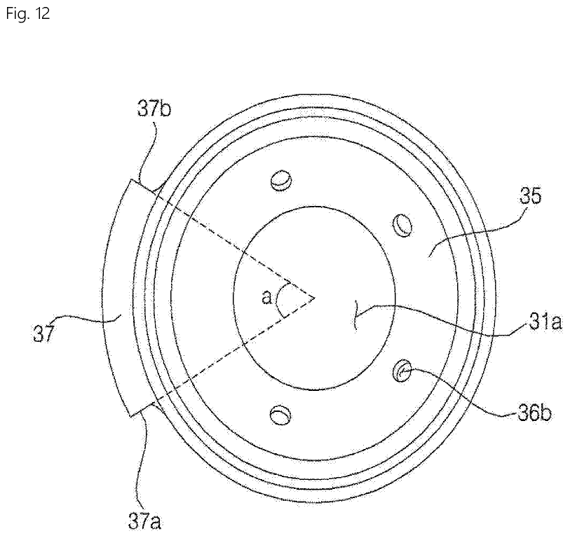

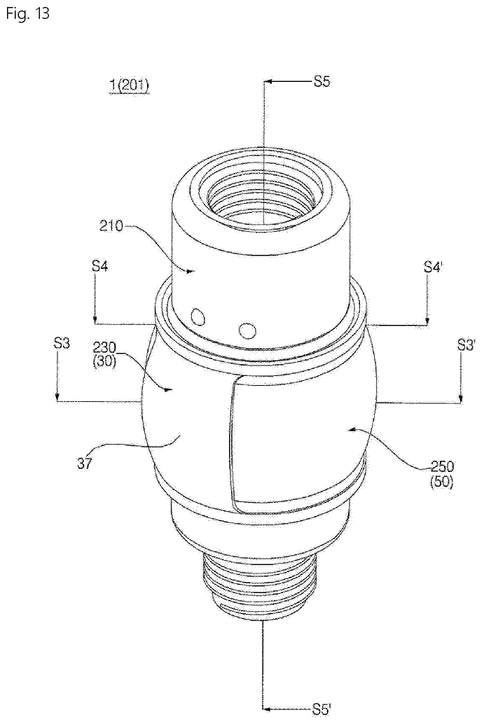

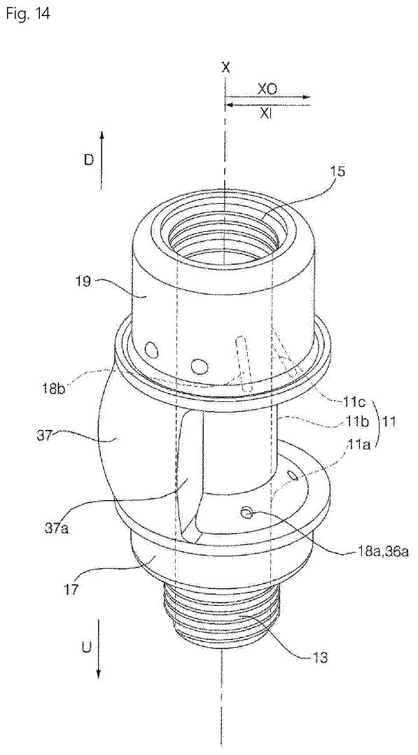

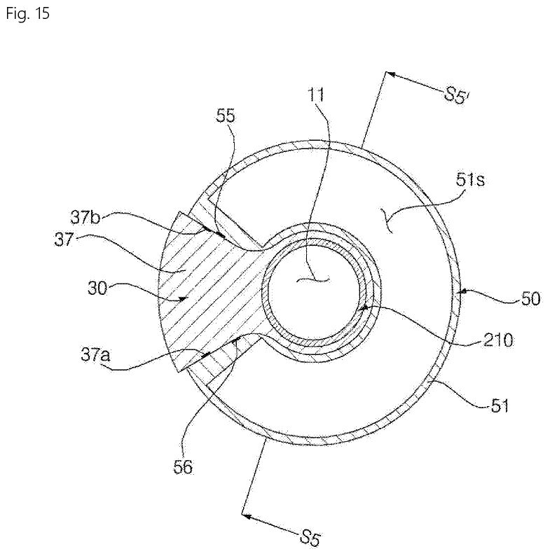

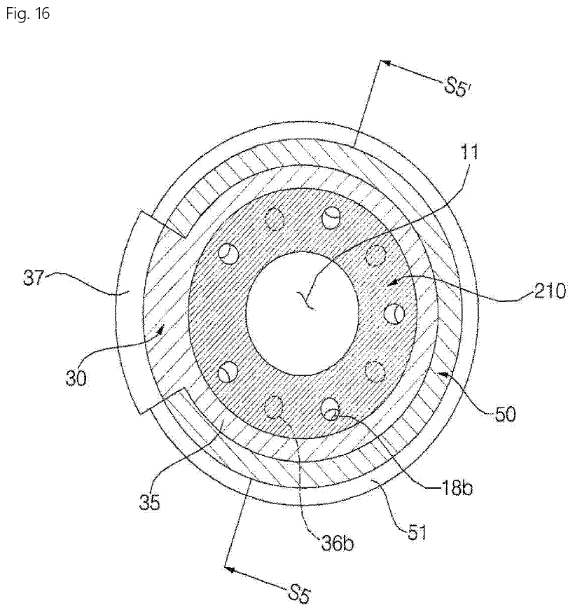

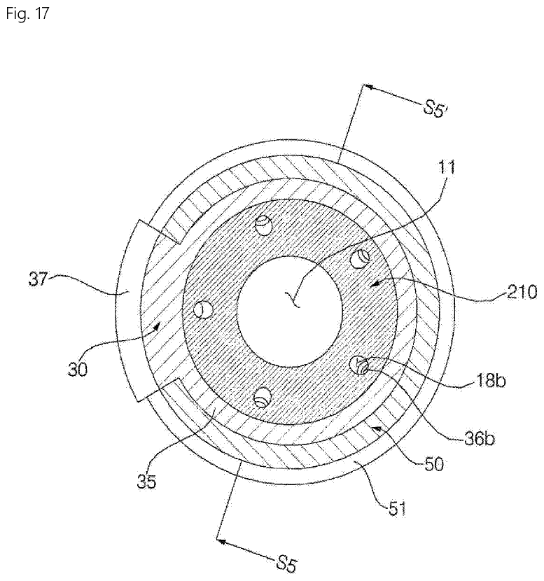

FIG. 3, FIG. 4, and FIG. 8 to FIG. 18, the shower device 201 according to the second embodiment will be described. In the description of the second embodiment, the configuration overlapping with the first embodiment is denoted by the same reference numerals, and description thereof will be omitted. The shower device 201 includes a main body 210, an auxiliary body 230, and a cartridge 250 according to the second embodiment.

Unlike the main body 110 according to the first embodiment, the main body 210 according to the second embodiment is not provided with the engaging portion 16. The central portion 12 is formed in a tubular shape, providing a rotation axis with respect to the auxiliary body 230.

The auxiliary body (30) is arranged to be rotatable about the central portion 12 secondary flow paths 23 and 25 are provided to be opened and closed according to the rotation of the auxiliary body 30. The shower device 201 is provided such that at least one of the upstream secondary path 23 and the downstream secondary path 25 is opened and closed according to the rotation of the auxiliary body 30.

The auxiliary body 30 includes a central tube portion 31 through which the central portion 12 penetrates. The central portion 12 penetrates the inner diameter side of the central tube portion 31. The central tube portion 31 is formed in a tubular shape extending along the central axis X. The through-hole 31a is formed along the center axis X in the center pipe part 31. The central portion 12 is disposed in the through hole 31a.

The auxiliary body 30 is arranged between the upstream step 17 and the downstream step 19. The central pipe part 31 is arranged between the upstream step 17 and the downstream step 19. Through this, the auxiliary body 30 may be accurately disposed on the main body 210, and when the auxiliary body 30 is rotated, the auxiliary body 30 may be guided to slide on the main body 210.

The auxiliary body 30 includes a step counterpart 32 which slidably contacts the downstream facing surface 17a and the upstream facing surface 19a. The step corresponding part 32 includes an upstream step corresponding part 33 disposed corresponding to the downstream facing surface 17a and a downstream step corresponding part 35 arranged corresponding to the upstream facing surface 19a.

The upstream step counterpart 33 may form an inclined surface closer to the central axis X toward the downstream direction. The downstream step counterpart 35 may form an inclined surface closer to the central axis X toward the upstream direction.

The auxiliary body 30 is provided to sandwich the cartridge 50 between the upstream step counterpart 33 and the downstream step counterpart 35.

The upstream connection hole 36a is formed by connecting the ‘surface in contact with the cartridge 50’ and the ‘surface in contact with the main body 10’ of the auxiliary body 30. An end of the upstream connecting hole 36a is formed on the surface of the auxiliary body 30 in contact with the cartridge 50, and the upstream connecting hole 36a is formed on the surface of the auxiliary body 30 in contact with the main body 10.) Is formed. The upstream connection hole 36a may penetrate the upstream step counterpart 33. The plurality of upstream connection holes 36a may be spaced apart from each other in the circumferential direction.

The downstream connection hole 36b is formed by connecting the ‘surface in contact with the cartridge 50’ and the ‘surface in contact with the main body 10’ of the auxiliary body 30. The start end of the downstream connecting hole 36b is formed on the surface of the auxiliary body 30 in contact with the cartridge 50, and the downstream connection hole 36b is formed on the surface of the auxiliary body 30 in contact with the main body 10.) End is formed. The downstream connection hole 36b may penetrate the downstream step counterpart 35. The plurality of downstream connection holes 36b may be spaced apart from each other along the circumferential direction.

The auxiliary body 30 includes a holding part 37 protruding from the center tube part 31 to the outer diameter side. The holding portion 37 is formed extending in the up-downstream direction.

The holding part 37 provides a fixed end so that the cartridge 50 can be disposed on the outer diameter side of the auxiliary body 30. The holding portion 37 provides a fixed end so that the cartridge 50 can be fixedly arranged around the auxiliary body 30.

The holding part 37 may be formed in the acute angle range a with respect to the central axis X of the center tube part 31. The holding part 37 and the second inserting part 573 are formed within the acute angle (a), so that the cartridge 50 is easily elastically coupled or separated, but is assisted in the state in which the cartridge 50 is coupled. It can be attached to the body 30 stably.

The inner diameter side surface of the holding part 37 is fixed to the center pipe part 31. Both ends of the up-downstream direction of the holding part 37 are fixed to the upstream step counterpart 33 and the downstream step counterpart 35, respectively. The outer diameter side surface of the holding part 37 may be formed as a curved surface convex toward the outer diameter side. In order to increase the friction force when the user grips the shower device 1, grooves or protrusions may be formed on the outer diameter side of the holding part 37.

With the cartridge 250 coupled to the auxiliary body 30, the circumferential side surfaces 37a and 37b of the holding portion 37 may contact the circumferential side surfaces 56 and 55 of the cartridge 250, respectively..

The insertion opening 57 of the cartridge 250 is formed by opening so that the center tube portion 31 is inserted. The central tube part 31 is disposed in the first insertion part 571 of the cartridge 250. The holding part 37 is disposed in the second inserting part 573 of the cartridge 250.

Through the structure of the holding part 37 of the auxiliary body 30 and the insertion opening 57 of the cartridge 50, the auxiliary body is rotated when the cartridge 50 is rotated while the cartridge 50 is coupled to the auxiliary body 30. There is an effect that the rotational force is applied to (30). In particular, when the outer diameter side 59 of the cartridge 50 is protruded to the outer diameter side or the outer diameter side 59 has a structure such as a protrusion, the user can apply torque to the auxiliary body 30 with a smaller force have. In particular, the majority of the area of the outer surface of the shower device 201 in the state that the cartridge 50 is coupled may be the outer surface of the cartridge 50, the user while holding the cartridge 50, the auxiliary body 30 There is an effect that can rotate.

The upstream side 52 of the cartridge 250 may have an inclination corresponding to the upstream step counterpart 33. The downstream side 54 of the cartridge 250 may have an inclination corresponding to the downstream step counterpart 35.

The upstream communication hole 51a is formed by connecting the ‘surface of the cartridge 250 in contact with the auxiliary body 30’ and the ‘inner side partitioning the inner space 51s’. An upstream end of the upstream communication hole 51a is formed on the surface of the cartridge 250 in contact with the auxiliary body 30. The start end of the upstream communication hole 51a is disposed at a position corresponding to the end of the upstream connection hole 36a.

The downstream communication hole 51b is formed by connecting the ‘surface of the cartridge 250 in contact with the auxiliary body 30’ and the ‘inner side partitioning the inner space 51s’. An end of the downstream communication hole 51b is formed on the surface of the cartridge 250 in contact with the auxiliary body 30. The end of the downstream communication hole 51b is disposed at a position corresponding to the start end of the downstream connection hole 36b.

Referring to FIG. 18, in a state where the auxiliary body 30 is disposed at an angle with respect to the main body 10, the upstream communication hole 51a, the upstream connection hole 36a, and the upstream secondary flow path hole (18a) are connected to each other. An upstream secondary flow path (223) may be formed. In a state where the auxiliary body 30 is disposed at an angle with respect to the main body 10, the downstream communication hole 51b, the downstream connection hole 36b, and the downstream secondary port (18b) are connected to the downstream secondary flow path (225). Can be formed.

The upstream secondary flow path 223 and the downstream secondary flow path 225 may be formed by bending the outer diameter side from the main flow path 11. The description thereof is the same as in the first embodiment and will be omitted.

Only in the state where the auxiliary body 30 is disposed at a predetermined angle in accordance with the rotation, the connection holes 36a and 36b constitute a part of the secondary paths 223 and 225. As the auxiliary body 30 is rotated, the secondary flow paths 223 and 225 are opened or closed, and the function of adding predetermined additives Z to the water sprayed through the shower device 201 is turned on. Can be off.

The auxiliary body 30 is disposed across the secondary paths 23 and 25. The step corresponding part 32 of the auxiliary body 230 of the second embodiment is disposed across the secondary flow paths 223 and 225. The upstream step counterpart 33 and the downstream step counterpart 35 of the auxiliary body 230 are disposed to cross the upstream secondary path 223 and the downstream secondary path 225, respectively.

Through the two step corresponding parts 33 and 35 and the two connecting holes 36a and 36b of the auxiliary body 230, the auxiliary body 30 is accurately disposed on the main body 210, and the auxiliary body While the function of guiding the 30 sliding and sliding is improved, it is more effective to turn off the addition function by the double step corresponding part structure.

Referring to FIG. 18, the shower device 201 may further include a coupling part 260 coupling the auxiliary body 230 and the cartridge 50 to each other. The coupling part 260 may prevent leakage between the auxiliary body 230 and the cartridge 50. An elastic material (not shown) such as rubber may be disposed between the auxiliary body 230 and the cartridge 50 to prevent leakage.

The coupling part 260 may be formed by a rib protruding from one of the auxiliary body 30 and the cartridge 50 and a groove recessed into a shape that engages the rib in the other.

The coupling portion 260 couples the first coupling portion 261 that couples the upstream step counterpart 33 and the upstream side surface 52 with the downstream step counterpart 35 and the downstream side 54. It may include a second coupling portion (262). The first coupling part 261 may prevent leakage between the upstream step counterpart 33 and the upstream side surface 52. The second coupling part 262 may prevent leakage between the downstream step counterpart 35 and the downstream side 54.

The first coupling part 261 may be provided so that the ribs protruding from one of the upstream step counterpart 33 and the upstream side 52 and the groove recessed in the shape engaged with the other are engaged with each other. In the second embodiment, the ribs and the grooves of the first coupling portion 261 are the second ribs 38a and the first rib grooves 58a, respectively.

The second coupling part 262 may be provided such that the ribs protruding from one of the downstream step counterpart 35 and the downstream side 54 and the recessed grooves engaged with each other are engaged with each other. In the second embodiment, the rib and the groove of the second coupling portion 262 are the first rib 58b and the second rib groove 38b.

As described above, the first rib 58b and the first rib groove 58a will not be described.

The auxiliary body 30 may include a second rib groove 38b that engages with the first rib 58b when the cartridge 50 is coupled to the auxiliary body 30, and the cartridge 50 may have the auxiliary body 30. And a second rib 38a engaged with the first rib groove 58a when coupled thereto.

The second rib groove 38b and the first rib groove 58a are recessed in the shape of engaging with the first rib 58b. The first rib 58b and the second rib 38a protrude in a shape that engages the first rib groove 58a.

Referring to FIG. 18, the shower device 201 may include rotating rail parts 41 and 42 for slidingly guiding the rotation of the auxiliary body 30. The rotary rail parts 41 and 42 are provided between the main body 210 and the auxiliary body 30. The rotary rails 41 and 42 may include a rail formed on any one of the main body 210 and the auxiliary body 30, and a guide forming a negative portion along the movement trajectory of the rail on the other.

The rotary rail portions 41 and 42 may include an upstream rotary rail portion 41 and a downstream rotary rail portion 42. The upstream side rotating rail portion 41 may be disposed in the upstream step counterpart 33. The downstream rotating rail portion 42 may be disposed in the downstream step counterpart 35.

The upstream rotating rail portion 41 includes a rail 41a formed on one of the main body 210 and the auxiliary body 30, and a guide 41b for guiding the movement of the rail 41a to the other. Include. The downstream rotary rail portion 42 includes a rail 42a formed on one of the main body 210 and the auxiliary body 30, and a guide 41b for guiding the movement of the rail 42a to the other. Include.

When all of the predetermined additive Z of the cartridge 50 is exhausted, the user can replace it with another cartridge 50. If the desired additive Z of the cartridge 50 has not been exhausted, and the user wants to shower with raw water in which the prescribed additive Z has not been mixed, the user may use the cartridge (at the main body 210). The auxiliary body 30 may be rotated with respect to the main body 210 without removing the secondary 50, thereby blocking the secondary flow paths 23 and 25. When the secondary flow paths 23 and 25 are blocked, the water moves from the shower hose 3 to the shower head portion 5 only through the main flow path 11, so that the shower is not mixed with predetermined additives Z. Is possible. If the user does not want to exhaust the prescribed additives Z of the cartridge 50, and the user wants to take a shower with water mixed with the prescribed additives Z, the auxiliary body 30 may be replaced with the main body. When the auxiliary body 30 is disposed at the predetermined angle by pivoting with respect to 210, the secondary path s 23 and 25 may be opened. When the secondary flow paths 23 and 25 are opened, the water moves not only through the main flow path 11 but also through the internal space 51s, and showering is possible with water mixed with predetermined additives(Z).

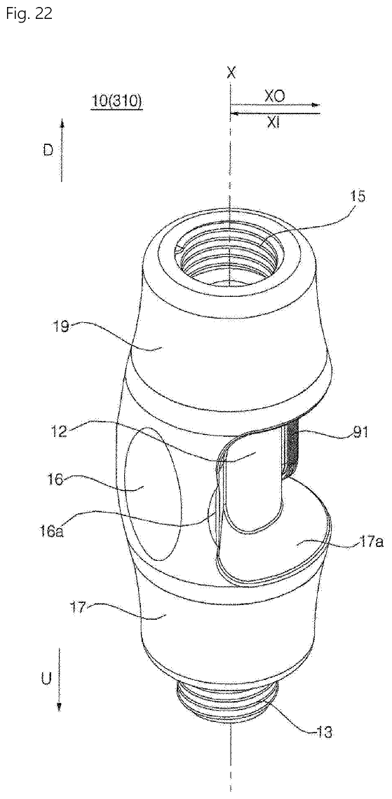

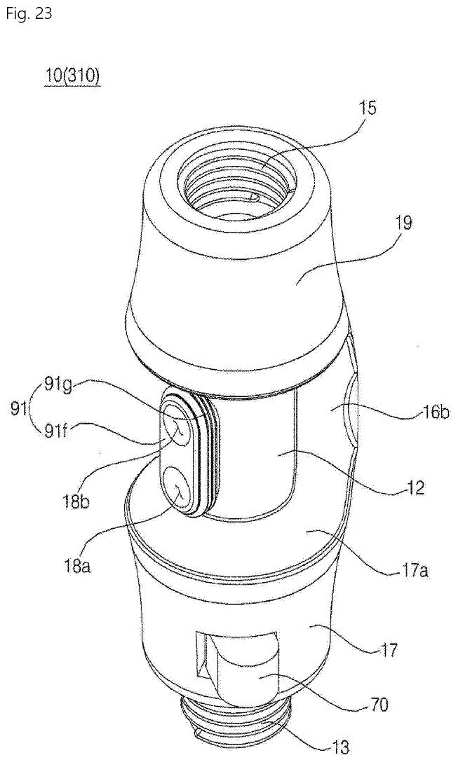

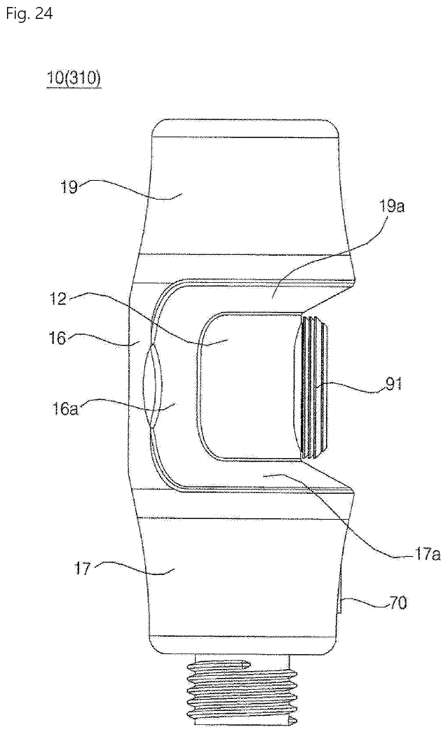

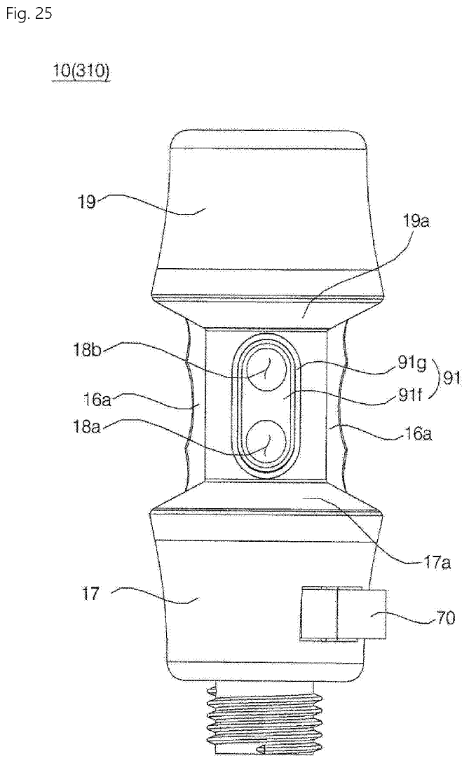

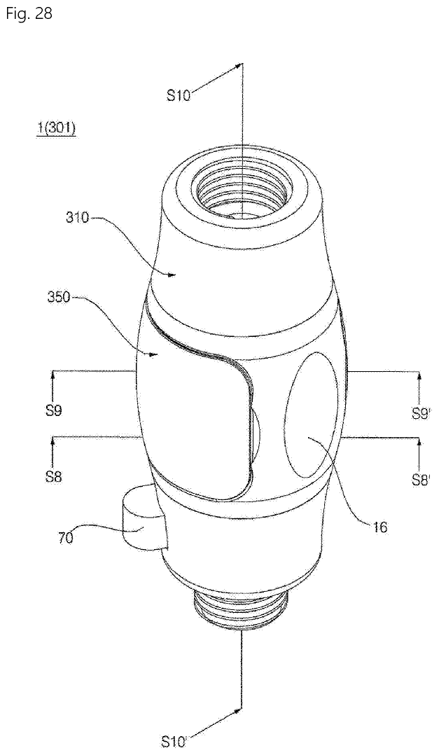

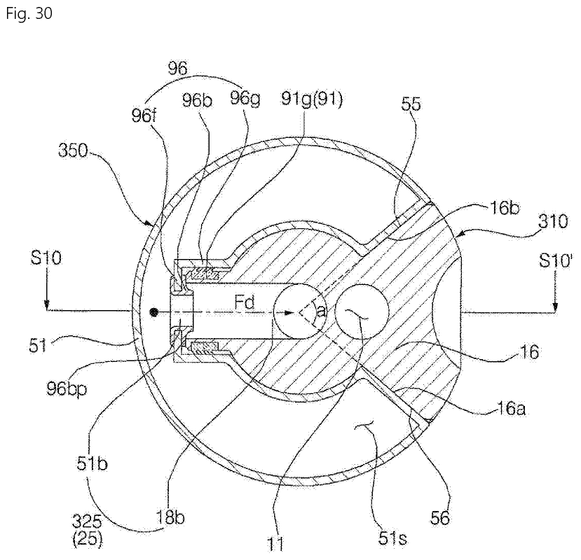

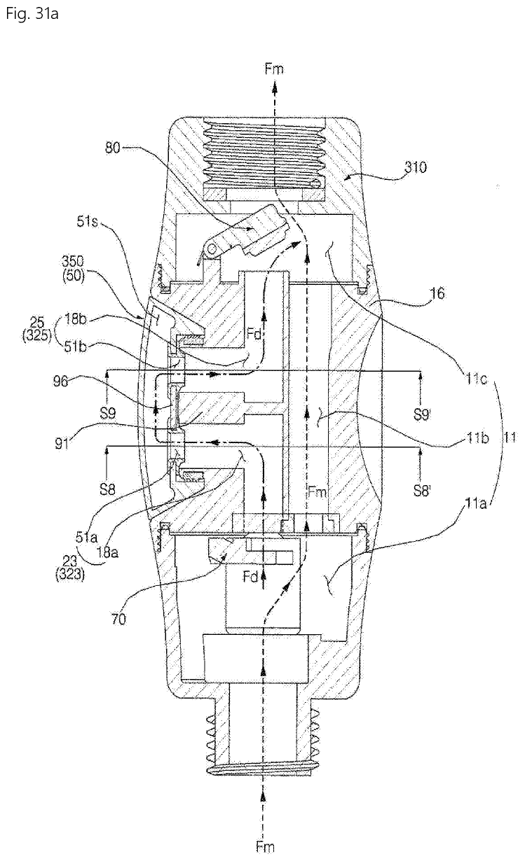

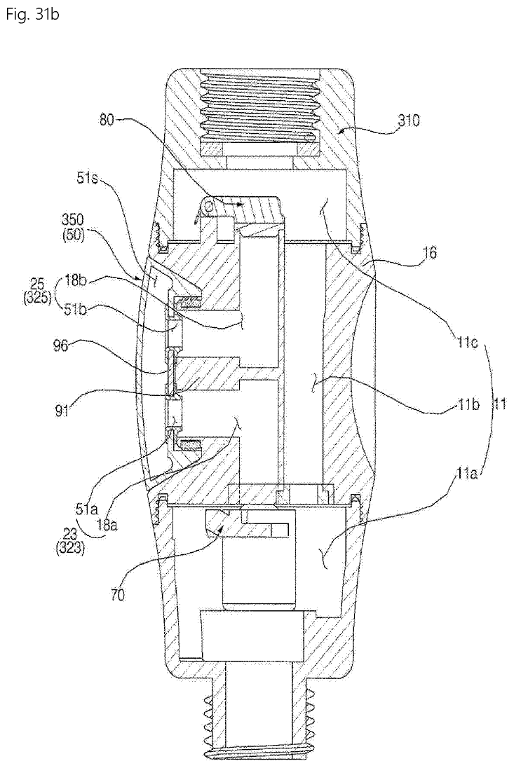

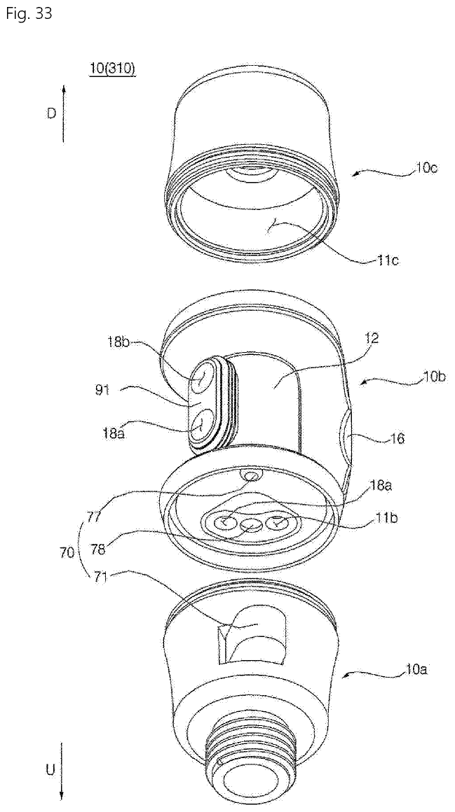

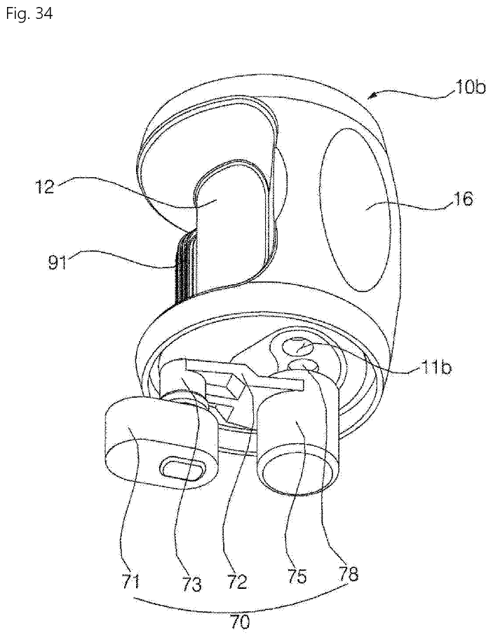

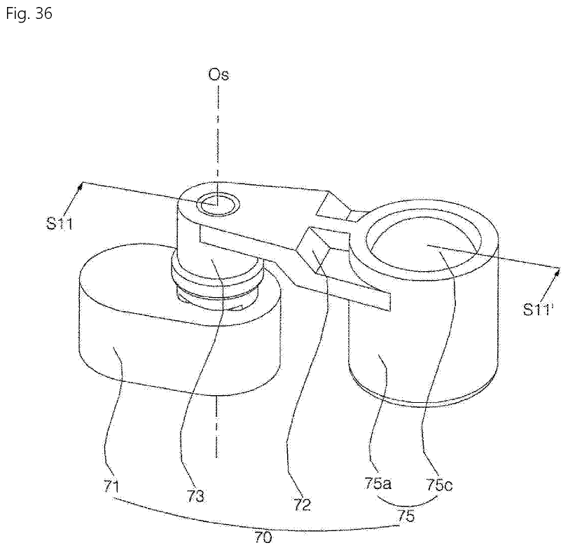

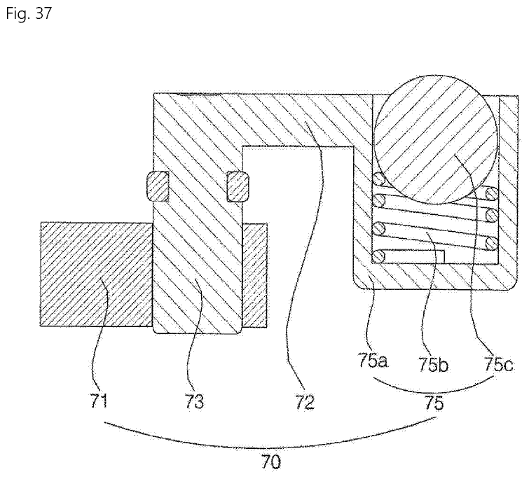

FIG. 22 to FIG. 38, a shower device 301 according to a third embodiment will be described. In the description of the third embodiment, the configuration overlapping with the first embodiment will be omitted by the same reference numerals and the description thereof will be omitted.

The shower device 301 according to the third embodiment includes a main body 310 and a cartridge 350. The shower device 301 includes a nozzle unit 91 and a nozzle counterpart 96. The shower device 301 may further include a switch module 70. The shower device 301 may further include a check valve 80.

One of the main body 310 and the cartridge 350 includes a nozzle portion 91 which protrudes in the other direction, and the other has a nozzle counterpart recessed in a shape engaged with the nozzle portion 91 (96). One of the central portion 12 and the cartridge 350 includes a nozzle portion 91 which protrudes in the other direction, and the other has a nozzle counterpart 96 recessed in a shape engaged with the nozzle portion 91.).

In the third embodiment, the nozzle portion 91 is formed in the main body 310, and the nozzle counterpart 96 is formed in the cartridge 350. The nozzle unit 91 protrudes from the main body 310 to the outer diameter side. The nozzle unit 91 may protrude from the central portion 12 to the outer diameter side. The nozzle counterpart 96 may be recessed from the inner diameter side of the cartridge 350 to the outer diameter side.

secondary flow paths 323 and 325 pass through the nozzle part 91. The secondary flow paths 323 and 325 penetrate through the nozzle part 91 and the nozzle counterpart 96. The upstream secondary path 323 and the downstream secondary path 325 may pass through the common nozzle portion 91. The upstream secondary path 323 and the downstream secondary path 325 may pass through the common nozzle portion 91 and the common nozzle counterpart 96. The upstream secondary path 323 and the downstream secondary path 325 may both penetrate through one nozzle unit 91.

The nozzle portion 91 includes a front portion 91f that forms an end in the protruding direction of the nozzle portion 91. The front portion 91f may be formed in an elongated shape in the up-downstream direction when viewed from the front.

An end of the upstream secondary port 18a and a start end of the downstream secondary port 18b may be disposed in the nozzle portion 91. The front portion 91f may be provided with a hole 18a constituting at least a portion of the upstream secondary path 323 and a hole 18b constituting at least a portion of the downstream secondary path 325. An end of the hole 18a (end of the upstream secondary 18a) and an end of the hole 18b (starting of the downstream secondary 18b) are disposed in the front portion 91f. The end of the hole 18a is disposed in an upstream region of the front surface 91f, and the end of the hole 18b is disposed in a downstream region of the front surface 91f.

The nozzle portion 91 includes a peripheral portion 91g that forms a side surface along the circumference of the front portion 91f. The peripheral portion 91g may include a gasket 91g for blocking leakage. The gasket 91g may extend along the circumference of the front portion 91f so as to contact the peripheral counterpart 96g. The gasket 91g may include ribs of elastic material extending along the circumference of the gasket 91g, and the ends of the ribs of the gasket 91g are provided to contact the peripheral counterpart 96g.

The nozzle counterpart 96 forms a groove 96s recessed in the centrifugal direction. The nozzle portion 91 is inserted into the groove 96s. In the combined state of the main body 310 and the cartridge 350, the nozzle portion 91 is inserted into the nozzle counterpart 96.

The nozzle counterpart 96 includes a front counterpart 96f facing the front face 91f. An upstream connecting portion 96a and a downstream connecting portion 96b, which will be described later, are disposed in the nozzle counterpart 96.

The nozzle counterpart 96 includes a peripheral counterpart 96g that surrounds the peripheral section 91g. Peripheral counterpart 96g is formed along the periphery of periphery 91g. The peripheral portion 91g and the peripheral counterpart 96g define the groove 96s.

The peripheral counterpart 96g is provided in contact with the peripheral section 91g. The gasket 91g is in contact with the peripheral counterpart 96g.

The nozzle counterpart 96 includes an upstream connecting portion 96a that protrudes so that at least a part thereof is inserted into the upstream secondary path 323 of the nozzle part 91. The upstream connecting portion 96a is inserted into the hole 18a of the nozzle portion 91.

The nozzle counterpart 96 includes a downstream connecting portion 96b that protrudes so that at least a part of the nozzle counterpart 91 is inserted into the downstream secondary path 325. The downstream connection portion 96b is inserted into the hole 18b of the nozzle portion 91.

The upstream connecting portion 96a forms a hole 51a constituting a part of the upstream secondary path 323. In the upstream connecting portion 96a, the end of the hole 51a (the start end of the upstream communication hole 51a) is disposed.

The downstream connection part 96b forms the hole 51b which comprises a part of the downstream secondary flow path 325. As shown in FIG. In the downstream connection part 96b, the terminal (end of the downstream communication hole 51b) of the said hole 51b is arrange|positioned.

The upstream connection portion 96a includes a packing portion 96ap disposed to be sandwiched between the front surface portion 91f and the front surface corresponding portion 96f. The packing portion 96ap is formed along the circumference of the end of the hole 51a.

The downstream connecting portion 96b includes a packing portion 96bp disposed to be sandwiched between the front portion 91f and the front side counter portion 96f. The packing portion 96bp is formed along the circumference of the end of the hole 51b.

The packing parts 96ap and 96bp may be formed of an elastic material such as rubber. The packing parts 96ap and 96bp are provided to be sandwiched between the front part 91f and the front part 96f.

The main body 310 may include an upstream case 10a, an intermediate case 10b, and a downstream case 10c. The upstream case 10a, the intermediate case 10b, and the downstream case 10c may be combined with each other to form the main body 310.

The midstream portion 11b is formed. The intermediate case 10b forms an upstream secondary 18a and a downstream secondary 18b. The center part 12 and the locking part 16 are formed in the intermediate case 10b. The nozzle unit 91 may be disposed in the intermediate case 10b. The check valve 80 may be disposed in the intermediate case 10b.

The end of the upstream secondary ing port 18a of the main body 310 is not formed in the downstream opposing surface 17a but is formed in the nozzle portion 91. The start end of the downstream secondary 18b of the main body 310 is not formed in the upstream opposing surface 19a, but is formed in the nozzle portion 91.

The start end of the upstream communication hole 51a of the cartridge 350 is not disposed on the upstream side surface 52 but is formed in the nozzle counterpart 96. The end of the downstream communication hole 51b of the cartridge 350 is not disposed on the downstream side 54 but is formed in the nozzle counterpart 96.

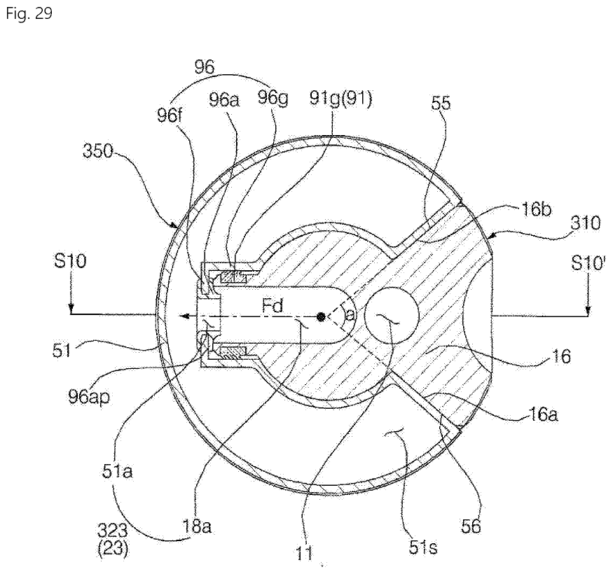

By referring to FIG. 29 to FIG. 31A, the upstream communication hole 51a and the upstream secondary port 18a may be connected to form an upstream secondary path 323. The downstream communication hole 51b and the downstream secondary port 18b may be connected to form a downstream secondary path 325.

The upstream secondary path 323 includes a first path portion extending in the downstream direction from the upstream portion 11a and a second path portion extending toward the nozzle portion 91 to the outer diameter side. An end of the first channel portion and a start end of the second channel portion are connected. The first channel portion and the second channel portion may be connected at right angles. The first channel portion may be formed inside the central portion 12.

The downstream secondary flow path 325 includes a third flow path portion extending toward the nozzle portion 91 toward the outer diameter side, and a fourth flow path portion extending in the upstream direction from the downstream portion 11c. An end of the third channel portion and a start end of the fourth channel portion are connected. The third channel portion and the fourth channel portion may be connected at right angles. The fourth flow path portion may be formed inside the central portion 12.

Referring to the arrow Fd, the water flowing along the secondary paths 23 and 25 sequentially moves the first path portion, the second path portion, the inner space 51s, the third path portion, and the fourth path portion. Go through.

Through the curved shapes of the secondary flow paths 323 and 325, the flow path resistance of the water flow flowing through the secondary flow paths 323 and 325 can be increased. While water is being supplied to the shower device 301 using the cartridge 50 filled with predetermined additives Z, excessively strong water flow flows into the internal space 51s of the cartridge 50 and excessively. It is possible to prevent the exhaustion of predetermined additives Z in a short time.

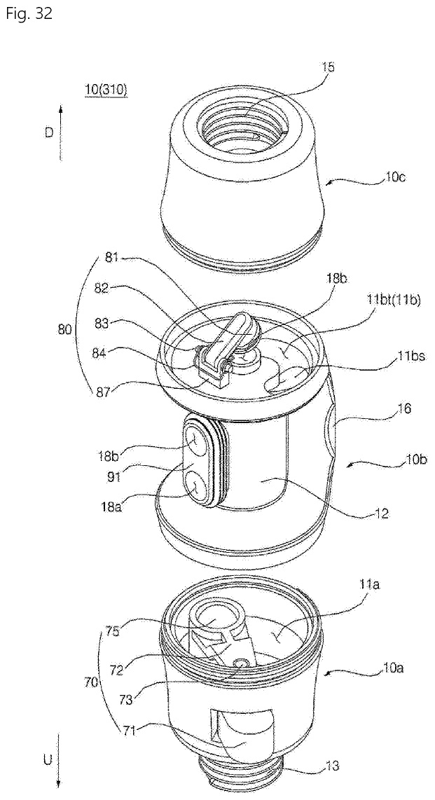

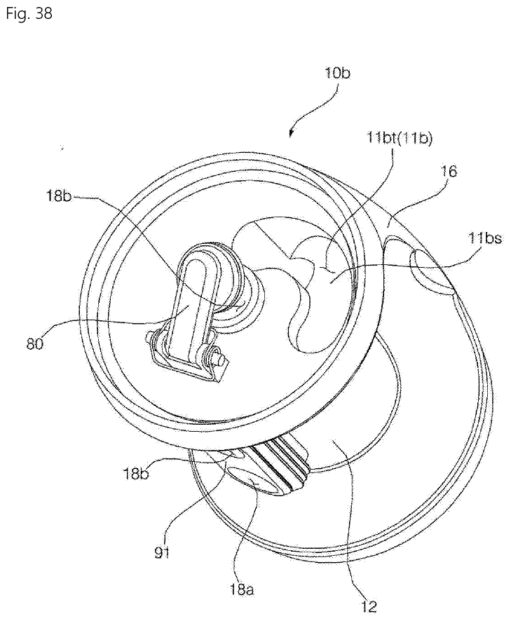

FIG. 32 and FIG. 38, the midstream portion 11b includes a vortex forming portion 11bt disposed at a portion connected from the midstream portion 11b to the downstream portion 11c. The vortex forming part 11bt forms a spiral flow path centering on the direction in which water is discharged from the downstream secondary flow path 325 to the downstream part 11c. The vortex forming part 11bt has a spiral inclined surface 11bs on its upstream side. In this way, water containing predetermined additives Z flowing out from the downstream secondary path 325 to the downstream portion 11c may be mixed with water flowing out from the downstream portion 11b to the downstream portion 11c. Do it. This is particularly useful in the intermediate mode state described below.

The switch module (70) is provided to select one of a plurality of modes in which the main flow path 11 or the secondary flow paths 23 and 25 are opened or closed.

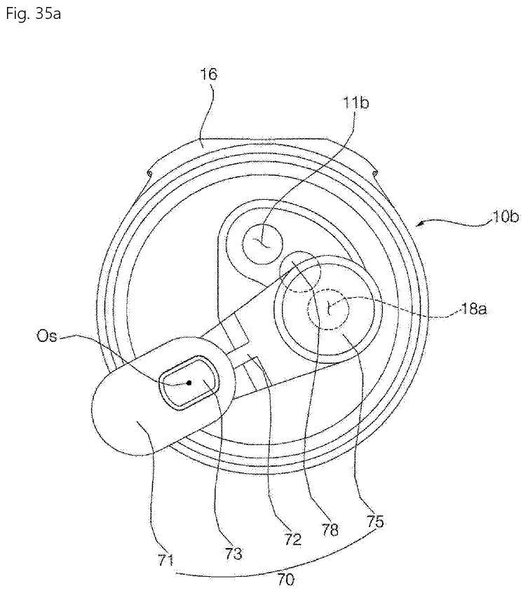

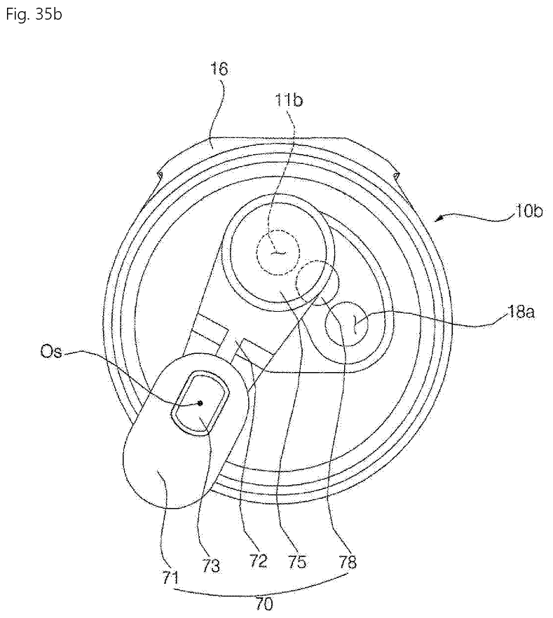

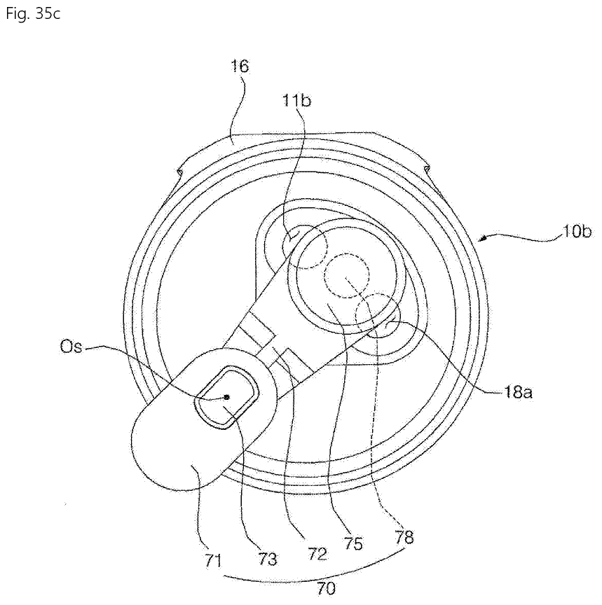

Referring to FIG. 35A, the plurality of modes may include a general mode for blocking secondary paths 23 and 25. The main flow path may be opened in the normal mode. In the normal mode, it may be provided to block the upstream basin flow path 23 and open the upstream portion (11b).

Referring to FIG. 35B, the plurality of modes may include an active mode that opens the secondary paths 23 and 25. In the active mode, the main flow path may be blocked. In the active mode, the upstream secondary path 23 may be opened to block the upstream portion 11b.

Referring to FIG. 35C, the plurality of modes may further include at least one intermediate mode that covers at least one portion of the secondary paths 23 and 25 and the middle part 11b. In the intermediate mode, at least one portion of the upstream secondary path 23 and the midstream portion 11b may be covered.

Referring to FIGS. 31A and 31B, the plurality of modes will be described below. In the normal mode, only the flow of water Fm on the main flow path 11 is generated and the flow of water Fd on the secondary flow paths 23 and 25 does not occur. At this time, the check valve 80, which will be described later, closes the end of the downstream secondary path 323 and blocks water from flowing into the secondary paths 23 and 25 from the downstream portion 11c. In the active mode, the flow of water Fm on the main flow path 11 does not occur, but only the flow of water Fd on the secondary flow paths 23 and 25. In the intermediate mode, both the flow of water Fm on the main flow path 11 and the flow of water Fd on the secondary flow paths 23 and 25 occur.

In the intermediate mode, a portion of the secondary paths 23 and 25 may be covered, a portion of the main path 11 may be covered, and a portion of the secondary paths 23 and 25 and the main path (see FIG. 35C). Part of 11) may be hidden.

Although not shown, the plurality of modes may include a plurality of intermediate modes having different levels at which the main flow path 11 or the secondary flow paths 23 and 25 are covered.

The switch module 70 may be provided to be caught at the beginning of the upstream secondary 18a in the normal mode. The switch module 70 may be provided to be caught at the beginning of the midstream portion 11b in the active mode. The switch module 70 may be provided to be caught by the intermediate locking portion 78 to be described later in the intermediate mode.

FIG. 32 to FIG. 37, the switch module 70 includes a cover 75 that moves along a predetermined trajectory to block the secondary paths 23 and 25 or the main path 11. The cover part 75 may block a part of the secondary flow paths 23 and 25 and/or a part of the main flow path 11.

The cover portion (75) is rotatably provided around the switch shaft Os. The switch axis Os may be parallel to the central axis X. The switch axis Os may be disposed at a position spaced apart from the central axis X. The start end of the upstream secondary ing port 18a and the start end of the middle stream portion 11b are disposed on the same horizontal plane (meaning a plane perpendicular to the center axis X). The start end of the upstream secondary ing port 18a and the start end of the middle stream portion 11b may be arranged at positions spaced apart by the same distance from the switch shaft Os.

The cover portion 75 includes a stopper 75c that directly blocks the flow path. The stopper 75c may be provided to partially expose the plug 75c in the opening direction of the cover body 75a. The end of the stopper 75c is formed in a convex shape. The stopper 75c may be formed in a spherical shape. The stopper 75c may be provided to block the flow path by receiving the elastic force in the downstream direction.

The cover part 75 may include a cover body 75a that accommodates the cover elastic member 75b. The cover body 75a guides the direction in which the stopper 75c moves elastically. The cover body 75a forms an inner space that is opened in the downstream direction, and a stopper 75c is disposed in an open portion of the inner space of the cover body 75a.

The cover portion 75 includes a cover elastic member 75b that applies an elastic force to the stopper 75c. The cover elastic member 75b is provided to apply an elastic force in the direction in which the plug 75c is inserted into the end of the flow path. The cover elastic member 75b may apply elastic force to the stopper 75c in the downstream direction. The cover elastic member 75b is disposed between the inner surface of the cover body 75a and the stopper 75c.

The switch module 70 includes an intermediate locking portion 78 provided with a portion of the plug 75c inserted and engaged in the intermediate mode. In the intermediate mode, a stopper 75c is inserted into the intermediate catching portion 16 in a direction perpendicular to the trajectory of the cover portion 75. The intermediate locking portion 78 forms a groove into which a part of the plug 75c is inserted.

The stopper 75c is inserted into the secondary paths 23 and 25 in a direction perpendicular to the trajectory of the cover portion 75 in the normal mode to block the secondary paths 23 and 25. The stopper 75c is inserted into the midstream portion 11b in a direction perpendicular to the trajectory of the cover portion 75 in the active mode to block the midstream portion 11b.

The stopper 75c may be inserted into the intermediate locking portion 78 in the downstream direction. The stopper 75c may be inserted into the start end of the upstream secondary port 18a (start end of the upstream secondary channel 323) in the downstream direction. The stopper 75c may be inserted at the start end of the midstream portion 11b in the downstream direction.

The groove of the intermediate locking portion 78 is formed recessed in the downstream direction. The starting end of the upstream basin 18a faces the upstream direction. The start end of the midstream portion 11b faces the upstream direction.

The start end of the upstream secondary ing port 18a, the start end of the middle stream portion 11b, and the intermediate locking portion 16 are disposed on the same horizontal plane (meaning a plane perpendicular to the center axis X). The start end of the upstream secondary ing port 18a, the start end of the upstream portion 11b, and the middle catching portion 16 may be arranged at positions spaced apart by the same distance from the switch shaft Os.

The switch module 70 includes an operation unit 71 exposed to the outside of the main body 310. The user can change the mode by moving the operation unit 71. The operation unit 71 may be provided to be rotated about the switch shaft Os. The operation unit 71 and the cover unit 75 may be disposed opposite to each other with respect to the switch shaft Os.

The switch module 70 includes a switch shaft portion 73 disposed on the switch shaft Os. The switch shaft portion 73 provides the rotation axis Os of the switch module 70. The switch shaft portion 73 is supported by the main body 310 so as to be rotatable about the switch shaft Os.

The switch module 70 includes a switch bar 72 connecting the operation unit 71 and the cover unit 75 to each other. The operation portion 71 and the cover portion 75 are fixed to the switch bar 72. The switch bar 72 is provided to rotate about the switch shaft Os. The switch shaft 73 may be fixed to the switch bar 72.

The switch module 70 includes a switch support 77 for rotatably supporting the switch shaft 73. The switch support 77 may be fixed to the main body 310.

Referring to FIG. 31A to FIG. 32, the check valve 80 is provided to open and close the secondary flow paths 23 and 25. The check valve 80 prevents backflow of water on the secondary path. When there is a water pressure of a predetermined level or more in the predetermined flow direction (Fd) in the secondary paths 23 and 25, the check valve 80 is provided to open the secondary paths 23 and 25. The check valve 80 blocks the water passing through the middle stream portion 11b from flowing into the secondary flow paths 23 and 25 from the downstream portion 11c.

The check valve 80 may be provided to open and close the downstream secondary path 325. The check valve 80 may be provided so as to be able to open and close the end of the downstream secondary port 18a (the end of the downstream secondary flow path 325). The check valve 80 is provided to elastically pressurize and close the end of the downstream secondary 18a in the upstream direction.

The check valve 80 includes a stopper 81 that directly blocks the end of the downstream secondary 18a. The check valve 80 includes a valve bar 82 to which the stopper 81 is fixed. The valve bar 82 is provided to be rotatable about a predetermined axis of rotation. The predetermined rotation axis of the valve bar 82 is disposed perpendicular to the central axis (X). The check valve 80 includes a valve shaft portion 83 that provides the predetermined axis of rotation. The valve bar 82 is rotatably provided around the valve shaft 83. The check valve 80 includes a valve support 87 for supporting the valve bar 82. The valve support 87 is fixed to the main body 310. The check valve 80 includes a valve elastic member 84 provided to apply an elastic force in a direction in which the check valve 80 covers the secondary flow paths 23 and 25. The valve resilient member 84 may be a torsion spring. The valve elastic member 84 can apply the elastic force to the valve bar 82 in the direction in which the stopper 81 covers the end of the downstream secondary 18a.

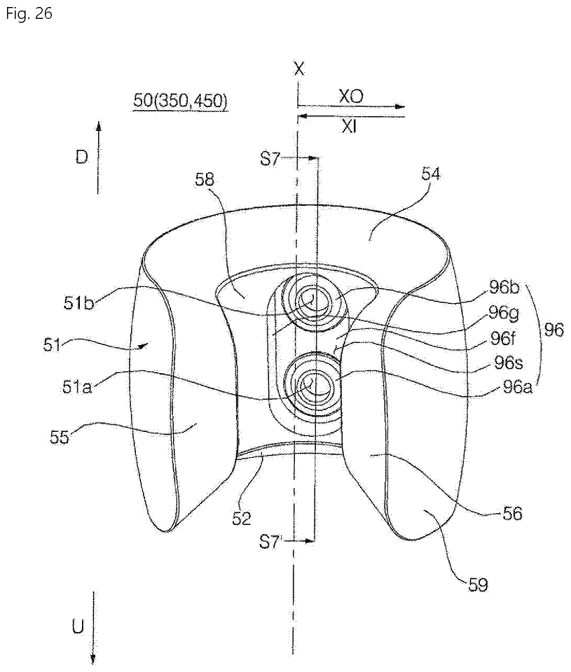

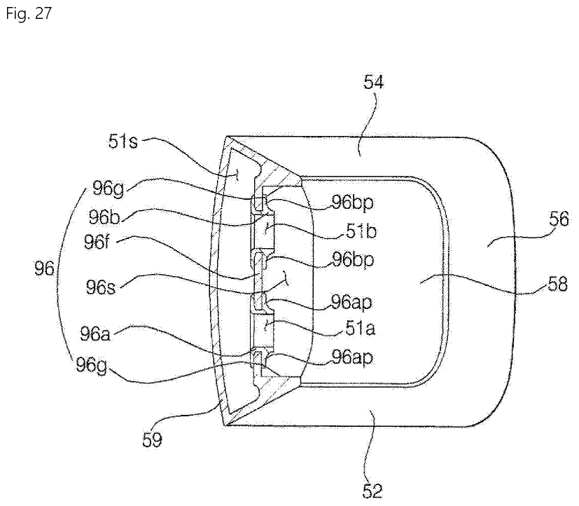

FIG. 26, FIG. 27 and FIG. 39, the shower device 401 according to the fourth embodiment will be described. In the description of the fourth embodiment, the components overlapping with the second and third embodiments will be denoted by the same reference numerals, and description thereof will be omitted.

The shower device 401 according to the fourth embodiment includes a main body 410, an auxiliary body 430, and a cartridge 450. The shower device 401 includes a nozzle unit 91 and a nozzle counterpart 96.

One of the auxiliary body 430 and the cartridge 450 includes a nozzle portion 91 which protrudes in the other direction, and the other includes a nozzle counterpart recessed in a shape engaged with the nozzle portion 91. 96). One of the center tube part 31 and the cartridge 350 includes a nozzle part 91 protruding in the other direction, and the other part of the nozzle counter part recessed in a shape engaged with the nozzle part 91 (96).

In the fourth embodiment, the nozzle portion 91 is formed in the main body 410, and the nozzle counterpart 96 is formed in the cartridge 450. The nozzle unit 91 protrudes from the auxiliary body 430 to the outer diameter side. The nozzle portion 91 may protrude from the center tube portion 31 to the outer diameter side. The nozzle counterpart 96 may be recessed from the inner diameter side of the cartridge 450 to the outer diameter side.

secondary flow paths 423 and 425 pass through the nozzle part 91. The secondary flow paths 423 and 425 penetrate through the nozzle part 91 and the nozzle counterpart 96.

An end of the upstream communication hole 51a and a start end of the downstream communication hole 51b may be positioned in the nozzle portion 91. The front portion 91f may be provided with a hole 36a constituting at least a portion of the upstream secondary path 423 and a hole 36b constituting at least a portion of the downstream secondary path 425. An end of the hole 36a (the end of the upstream communication hole 51a) and an end of the hole 36b (the start of the downstream communication hole 51b) are disposed in the front portion 91f. The end of the hole 36a is disposed in an upstream region of the front surface 91f, and the end of the hole 36b is disposed in a region downstream of the front surface 91f.

The upstream connection 96a of the cartridge 450 is inserted into the hole 36a of the nozzle portion 91. The downstream connection portion 96b of the cartridge 450 is inserted into the hole 36b of the nozzle portion 91.

Unlike the main body 310 according to the third embodiment, the main body 410 according to the fourth embodiment is not provided with the engaging portion 16. The central portion 12 is formed in a tubular shape to provide an axis of rotation with respect to the auxiliary body 430.

The end of the upstream secondary 18a of the main body 410 is not formed at the downstream facing surface 17a but may be formed at the central portion 12. The start end of the downstream secondary 18b of the main body 410 is not formed in the upstream facing surface 19a but may be formed in the central portion 12.

The auxiliary body 430 is arranged to be rotatable about the central part 12. The secondary flow paths 23 and 25 are provided to be opened and closed according to the rotation of the auxiliary body 430.

The upstream connection hole 36a and the downstream connection hole 36b of the auxiliary body 430 do not penetrate the step counterpart 32 but penetrate the center tube part 31. The start end of the upstream connection hole 36a of the auxiliary body 430 may be formed on the inner diameter surface of the center tube part 31. An end of the upstream connection hole 36a of the auxiliary body 430 is formed in the nozzle unit 91. The start end of the downstream connection hole 36b of the auxiliary body 430 is formed in the nozzle portion 91. An end of the downstream connection hole 36b of the auxiliary body 430 may be formed on the inner diameter surface of the center tube part 31.

The start end of the upstream communication hole 51a of the cartridge 450 is not disposed on the upstream side surface 52, but is formed in the nozzle counterpart 96. The end of the downstream communication hole 51b of the cartridge 450 is not disposed on the downstream side 54 but is formed in the nozzle counterpart 96.

Referring to FIG. 39, in a state in which the auxiliary body 430 is disposed at an angle with respect to the main body 410, the upstream communication hole 51a, the upstream connection hole 36a, and the upstream secondary hole 18a are connected to each other. An upstream secondary path 423 may be formed. In a state where the auxiliary body 430 is disposed at an angle with respect to the main body 410, the downstream communication hole 51b, the downstream connection hole 36b, and the downstream secondary hole 18b are connected to the downstream secondary flow path 425. Can be formed.

The upstream secondary channel 423 and the downstream secondary channel 425 may be formed to be bent to the outer diameter side. The description thereof is the same as in the third embodiment and will be omitted.

The central tube part 31 of the auxiliary body 430 is disposed across the secondary paths 423 and 425. The central tube part 31 of the auxiliary body 430 is disposed across the upstream secondary path 423 and the downstream secondary path 425.

The shower device 401 may include rotating rail parts 41 and 42 for sliding the rotation of the auxiliary body 430. The description thereof is the same as in the second embodiment and will be omitted.

1. A cartridge which connects between the shower hose and the shower head portion, has a central portion extending in an up-downstream direction, forms a main flow path for guiding water from the shower hose to the shower head portion, and has an internal space formed therein It is provided to detachable (detachable) to the outer diameter side of the central portion, the shower device comprising a main body for forming a secondary flow path for guiding water from the main flow path to the cartridge.

2. In the boundary of claim 1,
The main body, provides fixed end so that the cartridge can be disposed on the outer diameter side of the central portion, and includes a locking portion protruding toward the outer diameter side of the central portion, formed by extension in the up-downstream direction
And a locking end provided to allow the cartridge to be disposed on an outer diameter side of the center portion, and including a locking portion protruding toward the outer diameter side of the center portion and extending in an up-downstream direction.

3. In the boundary of claim 2, the shower device contains the following. The cartridge further includes an insertion opening formed in the cartridge, the insertion opening being opened so that the center portion is inserted and fixed, and the insertion opening includes a first insertion portion in which the center portion is disposed, and a second insertion portion in which the locking portion is disposed.

4. In the boundary of claim 2
The locking unit is formed in the acute angle range based on the central axis of the central portion.

5. In the boundary of claim 1,
The main body infers,
An upstream stepped portion formed upstream of the central portion extending to the outer diameter side, and a downstream stepped portion formed downstream of the central portion extended to the outer diameter side, the cartridge being provided to sandwich the upstream stepped portion and the downstream stepped portion Shower equipment.

6. In the boundary of claim 1,
Further comprising the cartridge,
One of the central portion and the cartridge includes a nozzle portion protruding in the other direction, and the other forms a nozzle counterpart recessed in a shape engaged with the nozzle portion,
The secondary flow path,
formed in the main body and the cartridge to guide water from the main flow path to the internal space and penetrate the nozzle unit and the nozzle counterpart.

7. The method of claim 6,
The secondary flow path infers,
An upstream secondary path that guides water from the upstream portion of the main flow path to the internal space; And
A downstream secondary path for guiding water from the inner space to a downstream portion of the main path;
The nozzle counterpart infers,
An upstream connecting portion which protrudes so that at least a portion of the nozzle portion is inserted into the upstream secondary path and forms a hole constituting a part of the upstream secondary path; And
And a downstream connection portion protruding so that at least a portion of the nozzle portion is inserted into the downstream secondary flow path and forming a hole constituting a portion of the downstream secondary flow path.

8. During the boundary of claim 1,
It further comprises a switch module for selecting any one of a plurality of modes, including the normal mode to block the secondary flow path and open the main flow path, and the active mode to open the secondary flow path and block the main flow path. Shower.

9. During the boundary of claim 8,
The plurality of modes infers,
And an intermediate mode covering a portion of at least one of the upstream secondary path and the upstream portion.

10. During the boundary of claim 8,
The secondary flow path,
An upstream secondary flow path for guiding water from the upstream portion of the main flow path to the cartridge; And
A downstream secondary path for guiding water from the cartridge to a downstream portion of the main path;
The main flow path,
The upstream portion;
The downstream portion; And
And an upstream portion connecting the upstream portion and the downstream portion,
The switch module is provided to block the upstream secondary path in the normal mode and open the upstream secondary path, open the upstream secondary path in the active mode and block the upstream secondary,
And a check valve provided to open and close the downstream secondary path to prevent backflow of water on the secondary path.

11. The method of claim 1,
Further comprising the cartridge,
The cartridge,
A first rib protruding from one of the upstream end and the downstream end and extending along the circumferential direction and a first rib groove recessed in a shape engaged with the first rib at the other one,
The main body,
And a second rib groove engaging the first rib when the cartridge is coupled to the main body, and a second rib engaging the first rib groove when the cartridge is coupled to the main body.

12. A main body connecting between the shower hose and the shower head and having a central portion extending in an up-downstream direction, the main body forming a main flow path for guiding water from the shower hose to the shower head; And
It is provided to detachable (detachable) the cartridge is formed in the inner space to the outer diameter side, and includes an auxiliary body disposed rotatably around the central axis,
The main body and the auxiliary body, a secondary flow path for guiding water from the main flow path to the cartridge is formed,
The shower device is provided to open and close the secondary flow path in accordance with the rotation of the auxiliary body.

13. The method of claim 12,
The auxiliary body,
A center tube portion through which the center portion passes through the inner diameter side; And
And a holding portion provided to allow the cartridge to be disposed on an outer diameter side of the auxiliary body, and including a holding portion protruding from the center tube portion to an outer diameter side and extending in an up-downstream direction.

14. The method of claim 12,
Further comprising the cartridge,
One of the auxiliary body and the cartridge, one of which comprises a nozzle portion protruding in the other direction, the other forms a nozzle corresponding portion recessed in the shape of engaging with the nozzle portion,
The secondary flow path,
A shower device formed in the main body, the auxiliary body, and the cartridge to guide water from the main flow path to the internal space and pass through the nozzle part and the nozzle counterpart.

15. A cartridge for use in the shower device of claim 1.

16. A cartridge for use in the shower device of claim 12.
